(19) United States
(12) Patent Application Publication
(10) Pub. No.: US 2026/0346171 A1
(43) Pub. Date: Nov. 5, 2026

(54) HOUSING ASSEMBLY FOR WATER PURIFIER AND WATER PURIFIER

(71) Applicants: FOSHAN MIDEA CHUNGHO WATER PURIFICATION EQUIPMENT CO., LTD., Foshan (CN); MIDEA GROUP CO., LTD., Foshan (CN)

(72) Inventors: Zudong MO, Foshan (CN); Guanchen ZHANG, Foshan (CN); Zhenkui CHANG, Foshan (CN); Zheng PAN, Foshan (CN); Tingjian HUANG, Foshan (CN); Baoyou CHENG, Foshan (CN); Yumin LIAO, Foshan (CN)

(21) Appl. No.: 19/121,226

(22) PCT Filed: Nov. 12, 2024
(86) PCT No.: PCT/CN2024/131612

§ 371 Date: Apr. 15, 2025

(30) Foreign Application Priority Data
Dec. 28, 2023 (CN) 202323618745.8
Dec. 28, 2023 (CN) 202323618815.X
Dec. 28, 2023 (CN) 202323619526.1
Dec. 28, 2023 (CN) 202323619846.7
Dec. 28, 2023 (CN) 202323619893.1

(51) Int. Cl. B01D 35/30

(52) U.S. Cl. CPC B01D 35/30; B01D 2201/0415

(57) ABSTRACT

A water purifier and a housing assembly for a water purifier. The water purifier includes a base body and a filter cartridge support base integrally formed with the base body. A semi-open accommodation space is provided inside the filter cartridge support base and the accommodation space is configured to accommodate a filter cartridge.

### CROSS-REFERENCES TO RELATED APPLICATIONS

The present application claims priority to Chinese patent application No. 202323619846.7 filed Dec. 28, 2023, entitled “Water Purifier,” Chinese patent application No. 202323619526.1 filed Dec. 28, 2023, entitled “Water Purifier and Housing Assembly thereof,” Chinese patent application No. 202323618745.8 filed Dec. 28, 2023, entitled “Water Purifier,” Chinese patent application No. 202323619893.1 filed Dec. 28, 2023, entitled “Water Purifier,” and Chinese patent application No. 202323618815.X filed Dec. 28, 2023, entitled “Water Purifier and Housing Assembly thereof,” which are incorporated herein by reference in their entireties.

### FIELD

The present application relates to the field of water purification device, and in particular, to a housing assembly for water purifier and a water purifier.

### BACKGROUND

In the related art, the filter cartridge in the water purifier is located in the filter cartridge support base. To improve the structural strength of the filter cartridge support base, the outer housing of the filter cartridge support base generally encloses the entire filter cartridge in the accommodation space of the filter cartridge support base and the wall thickness of the outer housing of the filter cartridge support base is increased. But such arrangement increases the weight of the water purifier base body, which increases the manufacturing cost and transportation cost of the water purifier base body.

An under sink water purifier is a water purifier mounted at the water supply terminal in the kitchen, which may provide clean water to every household. It is very easy, convenient, and reasonable to mount without taking up much space. When in use, the faucet is simply turned on to get clean water, which is fast and convenient. The under sink water purifier includes numerous components, and the housing of the under sink water purifier needs to be flipped a plurality of times during whole machine assembly. The assembly is cumbersome, production efficiency is low, and the components are prone to be damaged during flipping. There are a plurality of mount bases and fix components at the housing to fix the above-mentioned parts. The housing involves a large quantity of components, which have high production costs. In addition, there are many components needed to be assembled during assembly, and the assembly steps are cumbersome, which leads to low production efficiency.

### BRIEF SUMMARY

The present application provides a water purifier to reduce the manufacturing cost of a water purifier base body.

The water purifier according to the embodiments of the present application includes:
a base body; and
at least one filter cartridge support base, where the filter cartridge support base and the base body are integrally formed, a semi-open accommodation space being provided inside the filter cartridge support base, the accommodation space accommodating a filter cartridge.

According to the water purifier in the embodiments of the present application, by providing the accommodation space of the filter cartridge support base as semi-open, the weight of the filter cartridge support base is reduced, which reduces the weight of the entire base body and lowers the manufacturing cost and transportation cost of the water purifier.

In some embodiments, the filter cartridge support base is provided with a hollow part, where the hollow part communicates with the accommodation space.

In some embodiments, a plurality of hollow parts are provided, where at least one of the hollow parts is located at an end portion of the filter cartridge support base facing a water path plate.

In some embodiments, a cross-section of the filter cartridge support base is an arc, where a diameter of the arc is greater than a diameter of the filter cartridge.

In some embodiments, a difference between the diameter of the arc and the diameter of the filter cartridge is 1 mm-3 mm.

In some embodiments, a center angle corresponding to the arc is 180°-270°.

In some embodiments, a thickness of the filter cartridge support base is 1.5 mm-3.5 mm.

In some embodiments, a plurality of filter cartridge support bases are provided, where the plurality of filter cartridge support bases are provided side by side.

In some embodiments, a water path plate mount space is provided inside the base body, where an opening of the water path plate mount space faces a side of the base body, and where an opening of the accommodation space faces another side of the base body.

In some embodiments, a peripheral wall of the base body is provided with a mount port, where the mount port communicates with the accommodation space, the filter cartridge being mounted into the accommodation space through the mount port.

The present application provides a housing assembly for water purifier, including:
an enclose plate, where a mount space is formed through the enclose plate, a side of the mount space being open;
a filter cartridge mount base, where the filter cartridge mount base accommodates a filter cartridge;
a first mount base, where the first mount base accommodates a water path plate, the first mount base being connected to the filter cartridge mount base;
a second mount base, where the second mount base accommodates a booster pump, the second mount base being connected to the first mount base; and
a third mount base, where the third mount base accommodates a control panel, the third mount base being connected to the second mount base;
the filter cartridge mount base, the first mount base, the second mount base, and the third mount base are all provided inside the mount space, and an opening of an accommodation space formed by the first mount base, an opening of an accommodation space formed by the second mount base, and an opening of an accommodation space formed by the third mount base all face a side of the mount space.

According to the housing assembly for water purifier provided in the embodiments of the present application, a bottom wall of the first mount base is provided with a limit hole, where the limit hole limits the water path plate.

According to the housing assembly for water purifier provided in the embodiments of the present application, inside of the first mount base is provided with a plurality of fix blocks at intervals, where the fix blocks protrude from the bottom wall of the first mount base, the fix blocks abutting against the water path plate and being connected to the water path plate.

According to the housing assembly for water purifier provided in the embodiments of the present application, a bottom wall of the second mount base is provided with a plurality of plug holes, where the plug holes are connected to the booster pump.

According to the housing assembly for water purifier provided in the embodiments of the present application, the plug holes are threaded blind holes.

According to the housing assembly for water purifier provided in the embodiments of the present application, the plurality of plug holes are provided in array.

According to the housing assembly for water purifier provided in the embodiments of the present application, a bottom wall of the third mount base is provided with a buckle, where the buckle is connected to the control panel.

According to the housing assembly for water purifier provided in the embodiments of the present application, the buckle is a through hole.

According to the housing assembly for water purifier provided in the embodiments of the present application, the third mount base includes adjacent first side wall and second side wall, where one of the first side wall and the second side wall is provided with a limit plate, the limit plate and another of the first side wall and the second side wall forming a position slot, the control panel being embedded inside the position slot.

According to the housing assembly for water purifier provided in the embodiments of the present application, the enclose plate includes a plurality of sub-plates, where the plurality of sub-plates are connected in sequence to form the mount space.

According to the housing assembly for water purifier provided in the embodiments of the present application, the plurality of sub-plates include a first plate body, and the filter cartridge mount base includes a first end and a second end, where the first end is connected to the first plate body, the first plate body being provided with a mount port, the mount port communicating with the filter cartridge mount base.

According to the housing assembly for water purifier provided in the embodiments of the present application, the second end is provided with a communication port, and the communication port communicates with the first mount base.

According to the housing assembly for water purifier provided in the embodiments of the present application, the housing assembly for water purifier further includes a side plate, where the side plate is connected to the enclose plate, the side plate being covered at the mount space.

The present application further provides a water purifier, including:
the housing assembly for water purifier as described above;
a filter cartridge, where the filter cartridge is provided inside a filter cartridge mount base of the housing assembly;
a water path plate, where the water path plate is provided inside a first mount base of the housing assembly, and where the water path plate is connected to and communicates with the filter cartridge;
a booster pump, where the booster pump is provided inside a second mount base of the housing assembly, and where the booster pump is connected to and communicates with the water path plate; and
a control panel, where the control panel is provided inside a third mount base of the housing assembly, and where the control panel is connected to the booster pump.

According to the housing assembly for water purifier provided in the present application, by providing the opening of the accommodation space formed by the first mount base, the opening of the accommodation space formed by the second mount base, and the opening of the accommodation space formed by the third mount base to all face a side of the mount space, the frequency of flipping the housing assembly is reduced, which simplifies the assembly, reduces the probability of damage to parts such as the water path plate, the booster pump, and the control panel during assembly, and improves the yield rate. Moreover, it is convenient to adjust the connect structure between the water path plate, the booster pump, and the control panel during assembly, which improves the assembly efficiency.

The present application provides a water purifier and a housing assembly thereof, the housing assembly including:
an enclose plate, where a mount space is formed through the enclose plate;
a filter cartridge mount base, where the filter cartridge mount base accommodates a filter cartridge;
a first mount base, where the first mount base accommodates a water path plate;
a second mount base, where the second mount base accommodates a booster pump; and
a third mount base, where the third mount base accommodates a control panel;
the filter cartridge mount base, the first mount base, the second mount base, and the third mount base are provided inside the mount space, and at least two of the enclose plate, the filter cartridge mount base, the first mount base, the second mount base, and the third mount base are integrally formed as integrated members.

According to the housing assembly for water purifier in the embodiments of the present application, the filter cartridge mount base includes a first end and a second end, where the first end is provided with a mount port, the mount port being configured to mount or disassemble the filter cartridge.

According to the housing assembly for water purifier in the embodiments of the present application, the second end is provided with a connection port, where at least a part of the first mount base is located at the second end of the filter cartridge mount base.

According to the housing assembly for water purifier in the embodiments of the present application, a plurality of filter cartridge mount bases are provided, where a length direction of each filter cartridge mount base is perpendicular to an arrangement direction of the plurality of filter cartridge mount bases.

According to the housing assembly for water purifier in the embodiments of the present application, a bottom wall of the first mount base is provided with a plurality of support blocks, where the support blocks are connected to the water path plate.

According to the housing assembly for water purifier in the embodiments of the present application, a bottom wall of the second mount base is provided with a plurality of plug holes, where at least part of the booster pump is plugged into the plug holes.

According to the housing assembly for water purifier in the embodiments of the present application, the third mount base is provided with a first side wall, where the first side wall is provided with a fix plate, the fix plate limiting the control panel.

According to the housing assembly for water purifier in the embodiments of the present application, the first side wall is further provided with a plurality of fix columns, where the fix columns abut against the control panel to limit the control panel.

According to the housing assembly for water purifier in the embodiments of the present application, an opening of an accommodation space formed by the first mount base, an opening of an accommodation space formed by the second mount base, and an opening of an accommodation space formed by the third mount base all face a side of the mount space.

According to the housing assembly for water purifier in the embodiments of the present application, the enclose plate includes a plurality of sub-plates, where the plurality of sub-plates are connected in sequence to form the mount space.

According to the housing assembly for water purifier in the embodiments of the present application, a sub-plate connected to the first mount base among the plurality of sub-plates is a first plate body, where the first plate body is provided with a communication hole, a water pipeline of the water path plate being threaded through the communication hole.

According to the housing assembly for water purifier in the embodiments of the present application, the plurality of sub-plates include a second plate body, where the second plate body is connected to the filter cartridge mount base and is provided with a communication hole communicating with the mount port of the filter cartridge mount base.

According to the housing assembly for water purifier in the embodiments of the present application, the housing assembly for water purifier further includes a side plate, where the side plate is connected to the enclose plate, the side plate being covered at the mount space.

The present application further provides a water purifier, including:
the housing assembly for water purifier as described above;
a filter cartridge, where the filter cartridge is provided inside a filter cartridge mount base of the housing assembly;
a water path plate, where the water path plate is provided inside a first mount base of the housing assembly, and where the water path plate is connected to and communicates with the filter cartridge;
a booster pump, where the booster pump is provided inside a second mount base of the housing assembly, and where the booster pump is connected to and communicates with a pipeline at the water path plate; and
a control panel, where the control panel is provided inside a third mount base of the housing assembly, and where the control panel is connected to the booster pump.

According to the housing assembly for water purifier in the embodiments of the present application, at least two of the enclose plate, the filter cartridge mount base, the first mount base, the second mount base, and the third mount base are integrally formed into an integrated member, which reduces the quantity of components in the housing assembly, reduces production steps and required production machines, reduces costs, simplifies the assembly steps of the housing assembly, and improves the production efficiency.

The present application provides a water purifier that reduces the quantity of flips of the base body during assembly.

The water purifier according to the embodiments of the present application includes:
a base body, where the base body is provided with a plug slot;
a filter cartridge support base, where the filter cartridge support base is provided at the base body and provided at a side of the plug slot; and
a water path plate, where the water path plate is plugged into the plug slot and fixedly connected to the filter cartridge support base.

According to the water purifier in the embodiments of the present application, by providing a plug slot for plugging at the base body, it is convenient to position the filter cartridge support base at a side of the base body and plug the water path plate at the same side. This design allows the water path plate to be directly plugged along the plug slot and fixedly connected to the base body during assembly of the water purifier, which avoids the cumbersome steps of repeatedly flipping and rotating the base body to adapt to assembly positions of different assemblies. In addition, by reducing the quantity of flips of the base body during assembly, the risk of accidental damage to the assemblies during assembly is correspondingly reduced, which improves the overall reliability of the product.

In some embodiments, the water path plate is provided with at least one first plug member, and the base body is provided with at least one second plug member, where the first plug member and the second plug member are detachably plugged and matched, and where one of the first plug member and the second plug member is a limit rib and another is a limit hole.

In some embodiments, a plurality of the first plug members are provided, where the first plug members are at intervals at the water path plate.

In some embodiments, the limit rib includes:
a strip section, where the strip section protrudes from a surface of the water path plate, and where a length of the strip section is greater than a diameter of the limit hole; and
a plug section, where the plug section is integrally formed with the strip section, and where the plug section is located inside the limit hole.

In some embodiments, a cross-section of the plug section is a “+” shape.

In some embodiments, an end face of a free end of the plug section is provided with a cut slope.

In some embodiments, an opening of the plug slot faces a side of the base body, and a peripheral wall of the base body is provided with a mount port.

In some embodiments, an end portion of the filter cartridge support base facing the water path plate is provided with a hollow part, where the filter cartridge is connected to the water path plate at the hollow part.

In some embodiments, the base body is provided with at least one reserve port for accessing a reserve water path.

In some embodiments, the filter cartridge support base and the base body are integrally formed.

In some embodiments, the base body is provided with a pump body mount slot, where an opening direction of the pump body mount slot is the same as an opening direction of the plug slot.

The present application provides a water purifier to reduce the noise generated during operation of a booster pump.

The water purifier according to the embodiments of the present application includes:
a base body; and
a pump body mount base, where the pump body mount base is provided with a mount hole, a booster pump being provided at a side of the pump body mount base, another side of the pump body mount base being provided with a fix base, the fix base being covered at the mount hole, the booster pump being connected to the pump body mount base through a bolt, the bolt being threaded through the mount hole, the fix base being covered at a part of structures of the bolt.

According to the water purifier in the embodiments of the present application, by providing a fix base at another side of the pump body mount base, the fix base is covered at the mount hole. In this way, during the operation of the water purifier, the vibration generated by the booster pump is first transmitted to the pump body mount base, and due to the presence of the bolt and the fix base, the vibration is dispersed and transmitted to the bolt and the fix base. This dispersion may reduce the intensity of vibration directly transmitted to the base body, which reduces the noise generated during the operation of the booster pump. The combination of the bolt and the fix base improves the stability of the mount structure of the booster pump in the water purifier, which also helps to reduce the transmission of vibration generated by the booster pump.

In some embodiments, the fix base includes:
a base main body, where the base main body protrudes from a surface of the pump body mount base, the base main body being provided around the mount hole in a circumferential direction of the mount hole; and
a connection beam, where the connection beam is integrally formed with the base main body, the connection beam spanning at a free end of the base main body, the connection beam being opposite to the mount hole.

In some embodiments, the base main body is provided with a notch, where the notch communicates with the mount hole.

In some embodiments, an end face of the bolt is in contact with the connection beam.

In some embodiments, the pump body mount base is provided with a mount slot, where the booster pump is provided inside the mount slot, a bottom wall of the mount slot being provided with a first protrusion, the mount hole being provided at the first protrusion.

In some embodiments, the bottom wall of the mount slot is provided with a second protrusion, where the first protrusion is provided at the second protrusion.

In some embodiments, a height h1 of the first protrusion is 8 mm-15 mm; and a height h2 of the second protrusion is 6 mm-12 mm.

In some embodiments, the pump body mount base is provided with a mount slot, where the booster pump is provided inside the mount slot, a bottom wall of the mount slot being provided with a recessed part, the mount hole being provided at the recessed part.

In some embodiments, the water purifier further includes a pump body mount plate, where the pump body mount plate is provided at a side of the pump body mount base, the pump body mount plate being detachably connected to the pump body mount base through a bolt, the booster pump being provided at the pump body mount plate.

In some embodiments, a plurality of the fix bases are provided, where the plurality of the fix bases are provided in array at a surface of the pump body mount base.

In some embodiments, the pump body mount base and the base main body are integrally formed.

The additional aspects and advantages of the present application are provided in the following description, which becomes apparent from the following description, or is learned through the practice of the present application.

### BRIEF DESCRIPTION OF THE DRAWINGS

To illustrate solutions in the embodiments of the present application or related art more clearly, the drawings used in the descriptions of the embodiments or related art are briefly described below. The drawings in the following description are some embodiments of the present application, and other drawings may be obtained based on these drawings without any creative effort for those skilled in the art.

FIG. 1 is a schematic structural diagram of a water purifier according to the present application;

FIG. 2 is another schematic structural diagram of a water purifier according to the present application;

FIG. 3 is another schematic structural diagram of a water purifier according to the present application;

FIG. 4 is a schematic inner structural diagram of a water purifier according to an embodiment of the present application;

FIG. 5 is a front view of a housing assembly according to an embodiment of the present application;

FIG. 6 is a first perspective view of a housing assembly according to an embodiment of the present application;

FIG. 7 is a second perspective view of a housing assembly according to an embodiment of the present application;

FIG. 8 is a third perspective view of a housing assembly according to an embodiment of the present application;

FIG. 9 is a fourth perspective view of a housing assembly according to an embodiment of the present application;

FIG. 10 is a fifth perspective view of a housing assembly according to an embodiment of the present application;

FIG. 11 is a front view of a housing assembly according to an embodiment of the present application;

FIG. 12 is a sixth perspective view of a housing assembly according to an embodiment of the present application;

FIG. 13 is a schematic structural diagram of a water purifier according to the present application;

FIG. 14 is another schematic structural diagram of a water purifier according to the present application;

FIG. 15 is an enlarged partial view of part A in FIG. 14;

FIG. 16 is a schematic structural diagram of FIG. 14 with a base body removed;

FIG. 17 is an enlarged partial view of part B in FIG. 16;

FIG. 18 is another schematic structural diagram of a water purifier according to the present application;

FIG. 19 is a schematic structural diagram of overall assembly of a water purifier according to the present application;

FIG. 20 is a schematic structural diagram of a water purifier according to the present application;

FIG. 21 is another schematic structural diagram of a water purifier according to the present application;

FIG. 22 is an enlarged partial view of part A in FIG. 21;

FIG. 23 is another schematic structural diagram of a water purifier according to the present application;

FIG. 24 is a cross-sectional view along direction A-A in FIG. 23;

FIG. 25 is an enlarged partial view of part B in FIG. 24; and

FIG. 26 is another schematic structural diagram of a water purifier according to the present application.

### REFERENCE SIGNS

100A: water purifier; 110A: base body; 111A: mount port;
120A: filter cartridge support base; 121A: accommodation space; 122A: hollow part;
130A: filter cartridge; 140A: water path plate mount space; 150A: water path plate; 160A: booster pump; 170A: control panel assembly; 180A: pump body mount base;
100B: housing assembly;
110B: enclose plate; 111B: first plate body; 112B: mount port; 113B: second plate body; 114B: communication hole;
120B: filter cartridge mount base; 121B: first end; 122B: second end; 123B: communication port;
130B: first mount base; 131B: limit hole; 132B: fix block; 133B: screw column;
140B: second mount base; 141B: plug hole;
150B: third mount base; 151B: buckle; 152B: limit plate; 153B: limit column; 154B: connection rib;
210B: filter cartridge; 220B: water path plate; 230B: booster pump; 240B: control panel;
100C: housing assembly;
110C: enclose plate; 111C: first plate body; 112C: communication hole; 113C: second plate body;
120C: filter cartridge mount base; 1201C: first end; 1202C: second end; 121C: mount port; 122C: connection port;
130C: first mount base; 131C: support block;
140C: second mount base; 141C: plug hole;
150C: third mount base; 151C: fix plate; 152C: fix column; 153C: connection rib;
100D: water purifier; 110D: base body; 111D: second plug member; 112D: plug slot; 113D: mount port;
120D: filter cartridge support base; 121D: hollow part; 122D: filter cartridge;
130D: water path plate; 131D: first plug member; 1311D: strip section; 1312D: plug section; 1313D: cut slope; 132D: threaded hole;
140D: pump body mount slot; 150D: booster pump; 160D: control panel assembly;
100: water purifier; 110: seat body; 111: mount port;
120: pump body mount base; 121: mount hole; 122: mount slot; 123: first protrusion; 124: second protrusion;
130: booster pump;
140: fix base; 141: base body; 142: connection beam; 143: notch;
150: bolt; 160: nut;
160: water path plate; 170: control panel assembly;
190: filter cartridge support base.

### DETAILED DESCRIPTION

Implementation of the present application is further described in detail below with reference to the drawings and embodiments. The following embodiments are intended to illustrate the application, but are not intended to limit the scope of the application.

In the description of the embodiments of the present application, it is to be noted that the orientation or positional relationships indicated by terms such as “center,” “longitudinal,” “lateral,” “upper,” “lower,” “front,” “rear,” “left,” “right,” “vertical,” “horizontal,” “top,” “bottom,” “inside,” “outside,” etc. are based on the orientation or positional relationship shown in the drawings, and are merely for the convenience of describing the embodiments of the present application and simplifying the description, rather than indicating or implying that the device or component stated must have a particular orientation, is constructed and operated in a particular orientation, and thus is not to be construed as limiting the embodiments of the present application. Moreover, the terms “first,” “second,” “third,” and the like are used for descriptive purposes only and are not to be construed as indicating or implying relative importance.

In the description of the present application, it should be noted that unless explicitly specified and defined otherwise, the terms “connected to” and “connected” shall be understood broadly, for example, it may be either fixedly connected or detachably connected, or may be integrated; it may be either mechanically connected, or electrically connected; it may be either directly connected, or indirectly connected through an intermediate medium. The specific meanings of the terms above in the present application may be understood by those skilled in the art in accordance with specific conditions.

In the embodiments of the present application, unless otherwise clearly stated and defined, the first feature being located “on” or “under” the second feature means that the first feature is in direct contact with the second feature or the first feature is in contact with the second feature by an intervening media. In addition, the first feature is “on,” “above” and “over” the second feature may refer to that the first feature is directly above or obliquely above the second feature, or simply refer to that the level height of the first feature is higher than that of the second feature. The first feature is “under,” “below” and “beneath” the second feature may refer to that the first feature is directly below or obliquely below the second feature, or simply refer to that the level height of the first feature is lower than that of the second feature.

In the description of this specification, description with reference to the terms “one embodiment,” “some embodiments,” “an example,” “specific example,” “some examples” and the like, refers to that specific features, structures, materials or characteristics described in combination with an embodiment or an example are included in at least one embodiment or example according to the embodiments of the present application. In this specification, schematic representations of the above terms are not necessarily directed to a same embodiment or example. Furthermore, the particular features, structures, materials or characteristics described may be combined in any suitable manner in any one or more embodiments or examples. In addition, those skilled in the art may combine the different embodiments or examples described in this specification, as well as the features of the different embodiments or examples, without conflicting each other.

A water purifier is a device used to filter impurities and harmful substances in water, removing pollutants such as bacteria, viruses, heavy metals, chlorine, and organic compounds from tap water or source water, providing users with clean and safe drinking and domestic water. The water purifier typically includes a water path plate, a filter cartridge, a booster pump, and a control panel assembly. The water path plate is a pipeline system in the water purifier, where the water path plate is responsible for guiding the raw water entering the water purifier to the filter cartridge for filtration, and then outputting the filtered water. The filter cartridge is a filter part in the water purifier, where the filter cartridge may remove impurities, bacteria, viruses, chlorine and other harmful substances from water based on different designs and constructions, to provide clean water. The control panel assembly is a central control part of the water purifier, where the control panel assembly may monitor water quality, control the operation and stop of the water purifier, and perform automatic cleaning and maintenance of the filter cartridge and the water path plate as needed. The booster pump is configured to increase the pressure of the water flow, which ensures that the water may pass through the filter cartridge smoothly and improves the filtration efficiency of the water purifier.

In the related art, the filter cartridge in the water purifier is located in the filter cartridge support base. To improve the structural strength of the filter cartridge support base, the outer housing of the filter cartridge support base generally encloses the entire filter cartridge in the accommodation space of the filter cartridge support base and the wall thickness of the outer housing of the filter cartridge support base is increased. But such arrangement increases the weight of the water purifier base body, which increases the manufacturing cost and transportation cost of the water purifier base body.

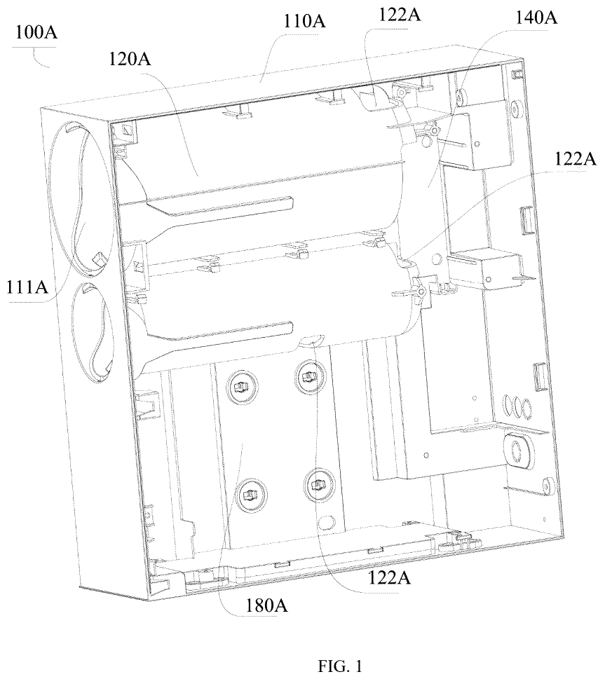

Below, the water purifier 100A provided in the present application is introduced through FIG. 1 to FIG. 3.

As shown in FIG. 1 to FIG. 3, the present application provides a water purifier 100A, including a base body 110A and at least one filter cartridge support base 120A. The filter cartridge support base 120A and the base body 110A are integrally formed, which may reduce the production cost of the base body 110A, ensure the structural stability of the entire water purifier 100A and the base body 110A, and reduce the probability of internal assemblies of the base body 110A loosening or breaking. A semi-open accommodation space 121A is provided inside the filter cartridge support base 120A, where the semi-open accommodation space 121A accommodates a filter cartridge 130A. In this way, not only is it convenient for users to replace the filter cartridge 130A, but it may also ensure the stability of the mounting of the filter cartridge 130A inside the water purifier 100A, reduce the displacement or looseness of the filter cartridge 130A, and effectively ensure the purification effect of the water purifier 100A. In addition, the filter cartridge support base 120A may support the filter cartridge 130A, which avoids deformation or even damage of the filter cartridge 130A due to compression during transportation of the water purifier 100A. In this way, the service life of filter cartridge 130A may be prolonged.

According to the water purifier 100A provided in the present application, by providing the accommodation space 121A of the filter cartridge support base 120A as semi-open, the weight of the filter cartridge support base 120A is reduced, which reduces the weight of the entire base body 110A and reduces the manufacturing cost and transportation cost of the water purifier 100A.

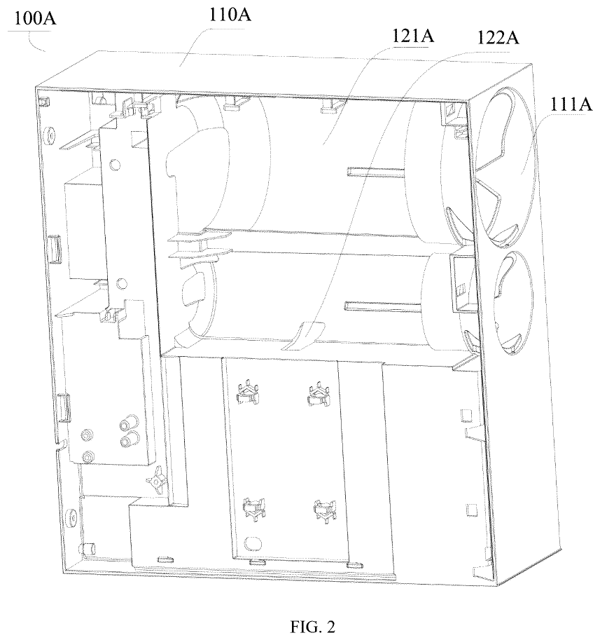

As shown in FIG. 1 and FIG. 2, in some embodiments of the present application, the filter cartridge support base 120A is provided with a hollow part 122A, where the hollow part 122A communicates with the accommodation space 121A. In this way, the design of the hollow part 122A reduces the weight of the filter cartridge support base 120A, which may reduce the use of materials in production of the filter cartridge support base 120A and lower the manufacturing cost.

As shown in FIG. 1 and FIG. 2, in some embodiments of the present application, a plurality of hollow parts 122A are provided, and at least one hollow part 122A is located at an end portion of the filter cartridge support base 120A facing a water path plate 150A. When the filter cartridge 130A is mounted at the filter cartridge support base 120A, the water path plate 150A and the filter cartridge 130A may be connected through the hollow part 122A, which ensures smooth water path inside the water purifier 100A and improves the working efficiency of the water purifier 100A.

As shown in FIG. 1 and FIG. 2, in some embodiments of the present application, a cross-section of the filter cartridge support base 120A is an arc, and a diameter of the arc is larger than a diameter of the filter cartridge 130A. In this way, it may ensure that there is a gap between the filter cartridge 130A and an inner wall of the filter cartridge support base 120A, which reduces the frictional force generated when the filter cartridge 130A is mounted at the filter cartridge support base 120A, reduces the wear at the surface of the filter cartridge 130A, and prolongs the service life of the filter cartridge 130A. Moreover, the arc-shaped filter cartridge support base 120A fits more closely to the shape of the filter cartridge 130A, which makes it easy to plug in or remove the filter cartridge 130A from the filter cartridge support base 120A, which improves the convenience of replacing the filter cartridge 130A.

In some embodiments of the present application, a difference between the diameter of the arc and the diameter of the filter cartridge 130A may be 1 mm-3 mm. For example, the difference between the diameter of the arc and the diameter of filter cartridge 130A may be 2 mm. In this way, a certain gap may be ensured between the filter cartridge 130A and the support base, which avoids direct contact between the filter cartridge 130A and the filter cartridge support base 120A, reduces wear and damage to the filter cartridge 130A, and prolongs the service life of the filter cartridge 130A. In addition, the design of the appropriate diameter difference makes it easier to plug or remove the filter cartridge 130A, further improving the convenience and operability of replacing the filter cartridge 130A.

In some embodiments of the present application, a center angle corresponding to the arc may be between 180° and 270°, for example, the center angle corresponding to the arc may be 180°. In this way, the filter cartridge support base 120A has a larger central angle to enclose a larger volume of the filter cartridge 130A, providing a more stable support structure for the filter cartridge 130A, which reduces the probability of shaking or loosening during use of the filter cartridge 130A, improves the safety and prolongs the service life of the water purifier 100A.

In some embodiments of the present application, a thickness of the filter cartridge support base 120A is 1.5 mm-3.5 mm, for example, the thickness of the filter cartridge support base 120A may be 2 mm. In this way, the weight of the filter cartridge support base 120A may be further reduced, which further reduces the weight of the base body 110A and reduces the manufacturing cost and transportation cost of the water purifier 100A.

As shown in FIG. 1 to FIG. 3, in some embodiments of the present application, a plurality of filter cartridge support bases 120A are provided, where the plurality of filter cartridge support bases 120A are provided side by side. In this way, the water purifier 100A may be mounted with a plurality of filter cartridges 130A, which may increase the processing capacity and filtration effect of the water purifier 100A, and also improve the filtration efficiency and purification capacity of the water purifier 100A. As such, the water purifier 100A may process more water, filter out more impurities and pollutants, and provide users with higher quality drinking water.

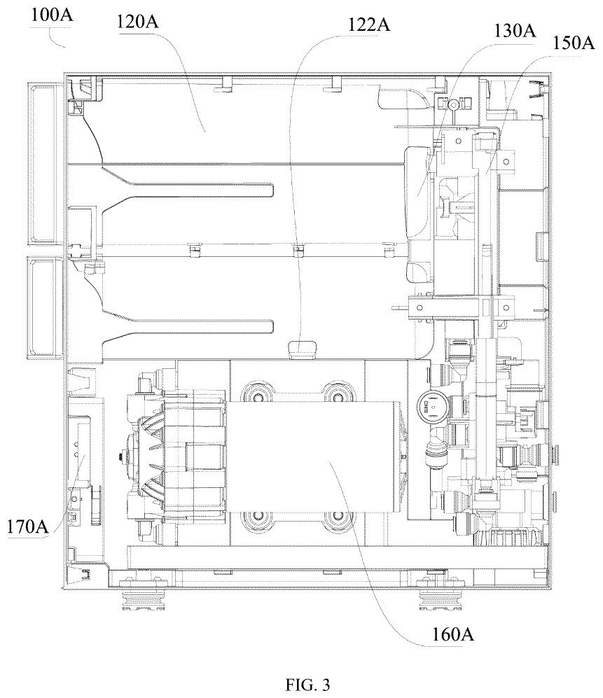

As shown in FIG. 1 to FIG. 3, in some embodiments of the present application, the base body 110A is provided with a water path plate mount space (not shown in the figures), and an opening of the water path plate mount space faces a side of the base body 110A. The water path plate 150A is mounted inside the water path plate mount space, and an opening of the accommodation space 121A faces another side of the base body 110A. In addition, in other embodiments of the present application, as shown in FIG. 3, the water purifier 100A is further provided with a booster pump 160A and a control panel assembly 170A. The booster pump 160A and the control panel assembly 170A are provided on the same side of the water path plate 150A. In this way, the filter cartridge support base 120A may separate the filter cartridge 130A from other parts, which may avoid the leakage of the filter cartridge 130A from affecting electronic devices at the booster pump 160A and the control panel assembly 170A, which improves the overall safety and reliability of the water purifier 100A.

As shown in FIG. 1 and FIG. 2, the peripheral wall of the base body 110A is provided with a mount port 111A, where the mount port 111A communicates with the accommodation space 121A, and the filter cartridge 130A is mounted into the accommodation space 121A through the mount port 111A. In this way, through the mount port 111A, users may easily mount the filter cartridge 130A into the accommodation space 121A without disassembling the entire water purifier 100A, which simplifies the mounting of the filter cartridge 130A, reduces the maintenance cost and time of replacing the filter cartridge 130A, and improves the usability of the water purifier 100A.

As shown in FIG. 1 to FIG. 3, the water purifier 100A provided in the present application is further provided with a control panel mount base (not shown in the figures), a pump body mount base 180A, and a water path plate mount base (not shown in the figures), where the water path plate mount space is provided inside the water path plate mount base. The base body 110A, the control panel mount base, the pump body mount base 180A, the filter cartridge support base 120A, and the water path plate mount base are all integrally formed, and the control panel mount base, the pump body mount base, and the water path plate mount base are all located at the same side of the base body. In this way, when mounting various assemblies at the base body 110A, the filter cartridge 130A may be mounted into the filter cartridge support base 120A from the mount port 111A, and then the booster pump 160A, the water path plate 150A, and the control panel assembly 170A may be mounted at the same side of the base body. In this way, when assembling the water purifier 100A, there is no need to flip the base body 110A, which makes the mounting faster and easier.

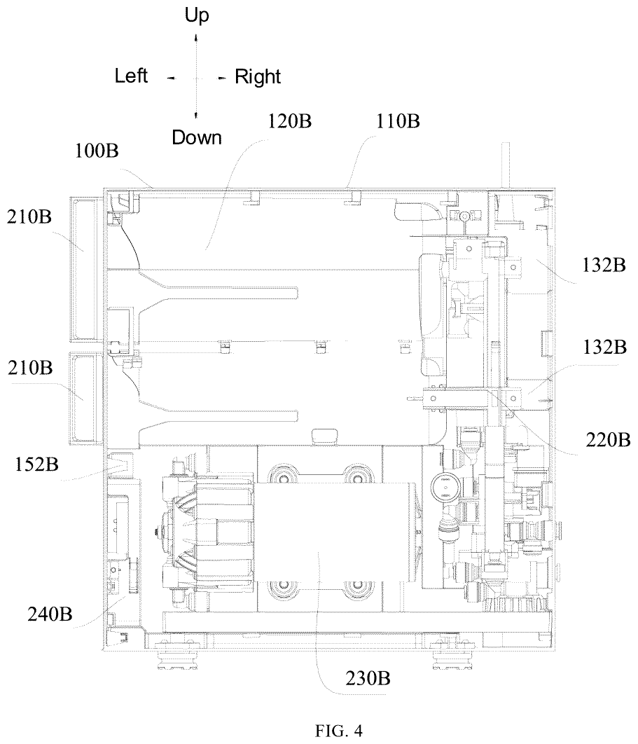

Below, a water purifier and a housing assembly thereof provided in the present application are described in conjunction with FIG. 4 to FIG. 8. An under sink water purifier is a type of water purifier mounted at the water supply terminal in the kitchen, which may provide clean water to every household. It is easy to mount, small in size, and does not take up much space. When in use, the faucet is simply turned on to obtain clean water, which is fast and convenient.

As shown in FIG. 4, the water purifier according to the embodiments of the present application includes a housing assembly 100B, a filter cartridge 210B, a water path plate 220B, a booster pump 230B, and a control panel 240B.

In an embodiment, the housing assembly 100B may provide a mount position and a storage space to fix the filter cartridge 210B, the water path plate 220B, the booster pump 230B, and the control panel 240B. Inside of the housing assembly 100B may be provided with a filter cartridge mount base 120B, a first mount base 130B, a second mount base 140B, and a third mount base 150B. The filter cartridge 210B is used for filtering water. The filter cartridge 210B may be a reverse osmosis (RO) filter cartridge or a PAC filter cartridge. The type and quantity of filter cartridges 210B may be selected based on the function of the water purifier. The filter cartridge 210B is provided inside the filter cartridge mount base 120B of the housing assembly 100B and is fixedly connected to the filter cartridge mount base 120B. The water path plate 220B may include a plurality of pipelines and valves, and may be connected to a water source to supply water to the water purifier. The water path plate 220B may also be used to discharge the waste water generated in the water purifier. The water path plate 220B is connected to and communicates with the filter cartridge 210B. Water enters the filter cartridge 210B through the water path plate 220B for filtration and is then provided to the user. The water path plate 220B is located inside the first mount base 130B of the housing assembly 100B and is fixedly connected to the first mount base 130B.

The booster pump 230B is connected to and communicates with the pipeline at the water path plate 220B. The booster pump 230B is configured to increase the pressure of water to drive water to flow smoothly in the water purifier. The booster pump 230B is provided inside the second mount base 140B of the housing assembly 100B and is fixedly connected to the second mount base 140B. The control panel 240B is provided inside the third mount base 150B of the housing assembly 100B and is fixedly connected to the third mount base 150B. The control panel 240B is connected to the booster pump 230B to adjust the work state of the booster pump 230B, which regulates the water flow rate inside the water purifier.

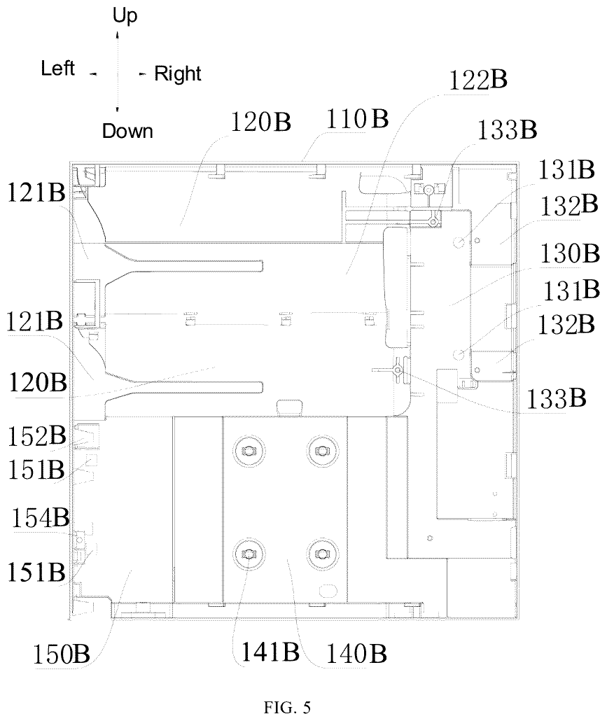

As shown in FIG. 5, the housing assembly 100B for water purifier according to the embodiments of the present application includes an enclose plate 110B, a filter cartridge mount base 120B, a first mount base 130B, a second mount base 140B, and a third mount base 150B.

In an embodiment, the filter cartridge mount base 120B accommodates and fixes the filter cartridge 210B; the first mount base 130B accommodates and fixes the water path plate 220B; the second mount base 140B accommodates and fixes the booster pump 230B; the third mount base 150B accommodates and fixes the control panel 240B. The first mount base 130B is connected to the filter cartridge mount base 120B, the second mount base 140B is connected to the first mount base 130B, and the third mount base 150B is connected to the second mount base 140B, to facilitate the connection between the filter cartridge 210B, the water path plate 220B, the booster pump 230B, and the control panel 240B.

The mount space is formed through the enclose plate 110B, and the filter cartridge mount base 120B, the first mount base 130B, the second mount base 140B, and the third mount base 150B are all provided inside the mount space. A side of the mount space is open for mounting or disassembling the filter cartridge 210B, the water path plate 220B, the booster pump 230B, and the control panel 240B. The accommodation space formed by the first mount base 130B is provided with an opening for mounting or disassembling the water path plate 220B through the opening. For ease of description, a side wall of the first mount base 130B opposite to the opening is the bottom wall of the first mount base 130B. The accommodation space formed by the second mount base 140B is provided with an opening for mounting or disassembling the booster pump 230B through the opening. A wall surface of the second mount base 140B opposite to the opening is the bottom wall of the second mount base 140B. The accommodation space formed by the third mount base 150B is provided with an opening for mounting or disassembling the booster pump 230B through the opening. A wall surface of the third mount base 150B opposite to the opening is the bottom wall of the third mount base 150B.

The opening of the accommodation space formed by the first mount base 130B, the opening of the accommodation space formed by the second mount base 140B, and the opening of the accommodation space formed by the third mount base 150B all face a side of the mount space. As such, the water path plate 220B, the booster pump 230B, and the control panel 240B may all be assembled from the side of the mount space, which avoids the need to flip the housing assembly 100B a plurality of times during assembly, and simplifies the assembly. In addition, when flipping the housing assembly 100B, due to factors such as the flipping speed and the position limitations of surrounding production machines, assembled components or circuits are prone to loosening, falling off, or collision damage. By providing the opening of the accommodation space formed by the first mount base 130B, the opening of the accommodation space formed by the second mount base 140B, and the opening of the accommodation space formed by the third mount base 150B to all face a side of the mount space, the probability of damage to components such as the water path plate 220B, the booster pump 230B, and the control panel 240B during assembly is reduced, and the yield rate is improved.

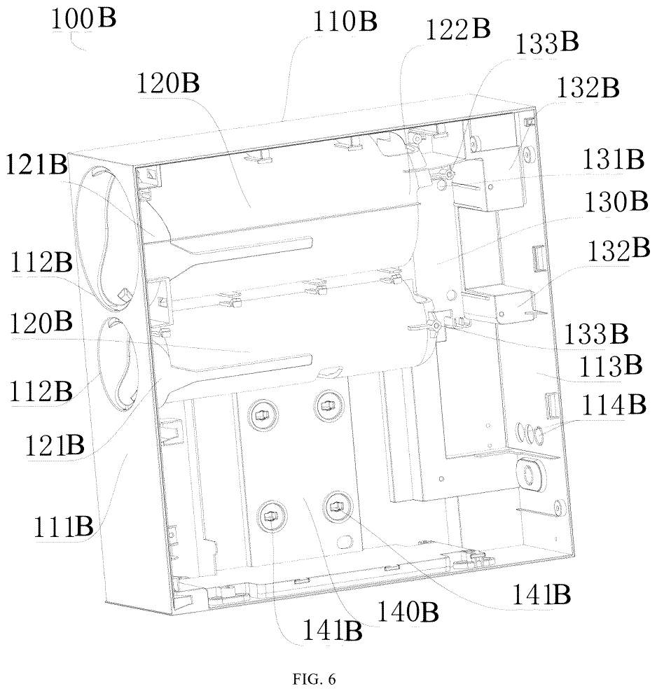

As shown in FIG. 6, the enclose plate 110B forms a rectangular mount space, where the mount space has two opposing first side surface and second side surface with largest areas. At least one of the first side surface and second side surface is open. The opening of the accommodation space formed by the first mount base 130B, the opening of the accommodation space formed by the second mount base 140B, and the opening of the accommodation space formed by the third mount base 150B may all face the opened first side surface or second side surface, which facilitates the mounting or disassembly of the water path plate 220B, the booster pump 230B, and the control panel 240B.

For example, when the first side surface is opened, the opening of the accommodation space formed by the first mount base 130B, the opening of the accommodation space formed by the second mount base 140B, and the opening of the accommodation space formed by the third mount base 150B all face the first side surface. In this way, during assembly of the water purifier, the water path plate 220B, the booster pump 230B, and the control panel 240B may all be assembled from the first side surface, which facilitates the adjustment of the connect structure between the water path plate 220B, the booster pump 230B, and the control panel 240B, and reduces the frequency of flipping the housing assembly 100B, improves the assembly efficiency, reduces the probability of damage to assembled components during assembly, and improves the yield rate.

In some embodiments, the second side surface may be opened, and the opening of the accommodation space formed by the first mount base 130B, the opening of the accommodation space formed by the second mount base 140B, and the opening of the accommodation space formed by the third mount base 150B all face the second side surface. In some embodiments, both the first side surface and the second side surface may be opened, and the opening of the accommodation space formed by the first mount base 130B, the opening of the accommodation space formed by the second mount base 140B, and the opening of the accommodation space formed by the third mount base 150B all face either the first side surface or the second side surface.

In the housing assembly 100B for water purifier according to the embodiments of the present application, the opening of the accommodation space formed by the first mount base 130B, the opening of the accommodation space formed by the second mount base 140B, and the opening of the accommodation space formed by the third mount base 150B are provided to all face a side of the mount space, which reduces the frequency of flipping the housing assembly 100B during assembly of the entire water purifier, simplifies the assembly, reduces the probability of damage to parts such as the water path plate 220B, the booster pump 230B, and the control panel 240B during assembly, and improves the yield rate. Moreover, it is convenient to adjust the connect structure between the water path plate 220B, the booster pump 230B, and the control panel 240B during assembly, which improves the assembly efficiency.

According to some embodiments of the present application, at least two of the enclose plate 110B, the filter cartridge mount base 120B, the first mount base 130B, the second mount base 140B, and the third mount base 150B are integrally formed as integrated members, which reduces the quantity of components of the housing assembly 100B, and reduces production steps and required production machines to reduce costs. The simplification of the components simplifies the assembly steps of the housing assembly 100B and improves the production efficiency.

For example, the enclose plate 110B and the filter cartridge mount base 120B may be integrally formed through injection molding, that is, the enclose plate 110B and the filter cartridge mount base 120B may be simultaneously formed through a single injection molding process to form an integrated member. In an embodiment, the first mount base 130B, the second mount base 140B, and the third mount base 150B may be integrally formed through injection molding, that is, the first mount base 130B, the second mount base 140B, and the third mount base 150B may be simultaneously formed through a single injection molding process to form an integrated member. In an embodiment, the enclose plate 110B, the filter cartridge mount base 120B, the first mount base 130B, the second mount base 140B, and the third mount base 150B may be integrally formed through injection molding, and the enclose plate 110B, the filter cartridge mount base 120B, the first mount base 130B, the second mount base 140B, and the third mount base 150B are formed as an integrated member. As such, the assembly procedure of the part is omitted, which greatly reduces the production cost, simplifies assembly steps, reduces the production cost, and improves the production efficiency.

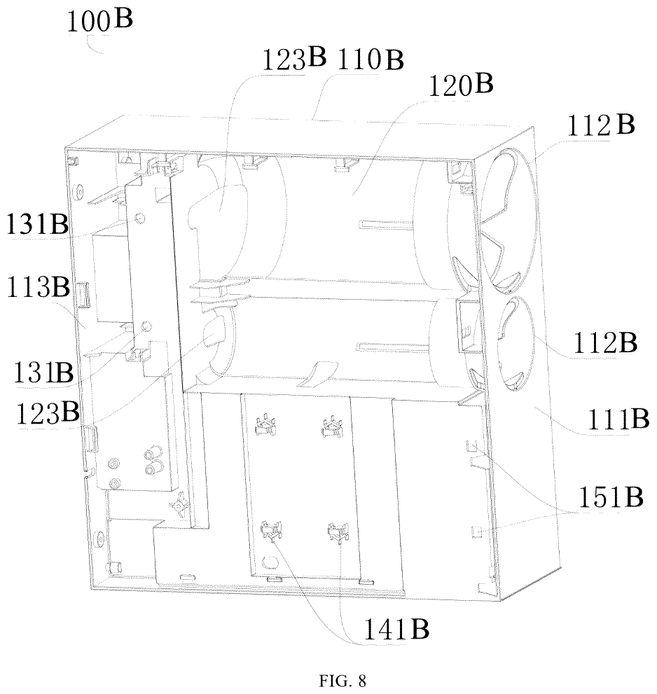

As shown in FIG. 5 and FIG. 6, according to some embodiments of the present application, a bottom wall of the first mount base 130B is provided with a limit hole 131B, where the limit hole 131B limits the water path plate 220B. A part of structures of the water path plate 220B may be plugged into the limit hole 131B. A plurality of limit holes 131B may be provided to improve the stability of the mounting of the water path plate 220B. As shown in FIG. 8, the limit hole 131B may be a through hole that penetrates the bottom wall of the first mount base 130B. In some embodiments, the water path plate 220B is provided with an electromagnetic valve, and a cable at the water path plate 220B may be connected to another side of the bottom wall of the first mount base 130B through the limit hole 131B for easy storage of the cable at the water path plate 220B.

As shown in FIG. 6, according to some embodiments of the present application, inside of the first mount base 130B is provided with a plurality of fix blocks 132B at intervals, and the fix block 132B protrudes from the bottom wall of the first mount base 130B. The fix block 132B abuts against the water path plate 220B and be connected to the water path plate 220B. The fix block 132B may fix and support the water path plate 220B, which aligns the pipeline at the water path plate 220B with the filter cartridge 210B for connection. The fix block 132B is connected to the water path plate 220B, and the fix block 132B may be connected to the water path plate 220B through a screw. A plurality of the fix blocks 132B may be provided, and the plurality of the fix blocks 132B are provided at intervals to form a snap-fix position between the fix blocks 132B. Part of structures of the water path plate 220B may be located in the snap-fix position to be fixed. In some embodiments, the fix block 132B may be a hollow structure with a reinforcement rib inside, to reduce the weight of the first mount base 130B. Another end of the fix block 132B is open for molding.

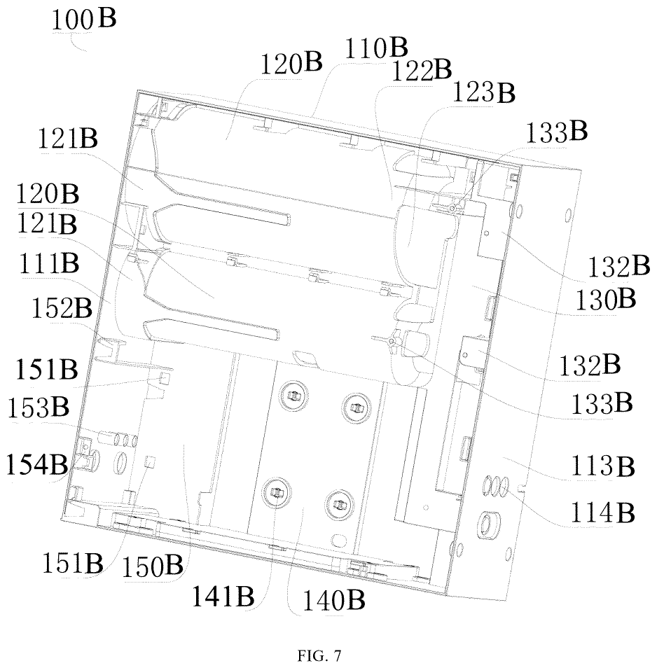

As shown in FIG. 6 and FIG. 7, according to some embodiments of the present application, at least one of the first mount base 130B and the filter cartridge mount base 120B is provided with a screw column 133B, where the screw column 133B is connected to the water path plate 220B to improve the stability of the mounting of the water path plate 220B. In some embodiments, an outer peripheral wall of the screw column 133B may be provided with a reinforcement rib to enhance the strength of the screw column 133B.

As shown in FIG. 7, according to some embodiments of the present application, the bottom wall of the second mount base 140B is provided with a plurality of plug holes 141B, where the plug hole 141B is connected to the booster pump 230B. At least a part of the booster pump 230B is plugged into the plug hole 141B to fix the booster pump 230B. The booster pump 230B may be provided with a plug member that is plugged into the plug hole 141B. During assembly, the plug member is aligned with the plug hole 141B and plugged into the plug hole 141B, and then fixed in the plug hole 141B. For example, the plug member may be a bolt, the plug hole 141B may be a threaded hole, or a nut may be embedded in the plug hole 141B, and after being plugged into the plug hole 141B, the bolt may be screwed tightly to fix the booster pump 230B. In some embodiments, a plurality of plug holes 141B and plug members may be provided, and the plug hole 141B and plug member are provided in array, with each plug member corresponding to each plug hole 141B one by one, to fix the booster pump 230B from a plurality of directions and avoid loosening or displacement of the booster pump 230B during operation.

According to some embodiments of the present application, the plug hole 141B may be a threaded blind hole, where the booster pump 230B and the plug hole 141B may be connected through a screw. The plug hole 141B may be formed after the second mount base 140B is formed. As shown in FIG. 8, the plug hole 141B may be a through hole, and a nut may be embedded in the plug hole 141B. Another side of the bottom wall of the second mount base 140B is provided with a rib to fix and limit the nut.

As shown in FIG. 5 and FIG. 7, according to some embodiments of the present application, the bottom wall of the third mount base 150B is provided with a buckle 151B, where the buckle 151B is connected to the control panel 240B to fix the control panel 240B. In the example of FIG. 7, the buckle 151B is a through hole, and a part of the structures of the control panel 240B is plugged into the buckle 151B. A plurality of the buckle 151B may be provided to fix the control panel 240B from a plurality of directions.

As shown in FIG. 5 and FIG. 7, according to some embodiments of the present application, the third mount base 150B includes adjacent first side wall and second side wall. One of the first side wall and the second side wall is provided with a limit plate 152B, and the limit plate 152B and another of the first side wall and the second side wall form a position slot. The control panel 240B is embedded in the position slot, to limit the control panel 240B in a height direction (as shown in FIG. 5) of the housing assembly 100B. As shown in FIG. 7, the limit plate 152B extends along a depth direction of the third mount base 150B, with a side of the limit plate 152B facing the second side wall. The position slot is formed between the limit plate 152B and the second side wall, and the control panel 240B is accommodated in the position slot. As shown in FIG. 4, a height of the control panel 240B (an up-down direction shown in FIG. 4 is the height direction of the control panel 240B) may be slightly greater than a distance between the limit plate 152B and the second side wall, to make a side of the control panel 240B abut against the fix plate, another side of the control panel 240B abut against the second side wall, and then the control panel 240B may be stably mounted inside the third mount base 150B.

As shown in FIG. 7, according to some embodiments of the present application, the first side wall is further provided with a plurality of limit columns 153B, and the limit column 153B abuts against the control panel 240B to limit the control panel 240B. A plurality of the limit columns 153B may be provided, and distribution of the limit columns 153B is related to the distribution of devices at the control panel 240B. The limit columns 153B should avoid compressing the devices at the control panel 240B. In some embodiments, the first side wall is further provided with a connection rib 154B, where the connection rib 154B is fixedly connected to the control panel 240B, for example, through a screw, to improve the stability of the mounting of the control panel 240B.

As shown in FIG. 6, according to some embodiments of the present application, the enclose plate 110B includes a plurality of sub-plates, where the plurality of sub-plates are connected in sequence to form the mount space. The filter cartridge mount base 120B, the first mount base 130B, the second mount base 140B, and the third mount base 150B are all located inside the mount space, and the filter cartridge mount base 120B, the first mount base 130B, the second mount base 140B, and the third mount base 150B may all be connected to the sub-plate. As shown in FIG. 6, the enclose plate 110B may include four sub-plates, where the four sub-plates are connected in sequence to form a rectangular mount space. A part of structures of the sub-plates constitutes part of side walls of the first mount base 130B, the second mount base 140B, and the third mount base 150B. It should be noted that this is only an embodiment and does not limit the quantity of the sub-plates or the shape of the mount space. The quantity of the sub-plates may also be 5, 6, or 7, etc.

As shown in FIG. 7 and FIG. 8, in some embodiments, the enclose plate 110B protrudes from the bottom wall of the first mount base 130B, the second mount base 140B, or the third mount base 150B. That is, the enclose plate 110B protrudes from the bottom wall of the first mount base 130B in an opposite direction to the opening of the accommodation space formed by the first mount base 130B. In an embodiment, the enclose plate 110B protrudes from the bottom wall of the second mount base 140B in an opposite direction to the opening of the accommodation space formed by the second mount base 140B. In an embodiment, the enclose plate 110B protrudes from the bottom wall of the third mount base 150B in an opposite direction to the opening of the accommodation space formed by the third mount base 150B. Thus, a certain accommodation space is formed at the bottom wall of the first mount base 130B, the second mount base 140B, or the third mount base 150B in the direction away from the corresponding opening, to accommodate cables or other parts inside the water purifier.

As shown in FIG. 6 and FIG. 8, according to some embodiments of the present application, the plurality of sub-plates include a first plate body 111B, and the filter cartridge mount base 120B includes a first end 121B and a second end 122B. The first end 121B is connected to the first plate body 111B, and the first plate body 111B is provided with a mount port 112B, and the mount port 112B communicates with the filter cartridge mount base 120B. The filter cartridge 210B may be mounted or disassembled through the mount port 112B, and when replacing the filter cartridge 210B, there is no need to disassemble the sub-plate. The filter cartridge 210B may be mounted by plugging through the mount port 112B, which is convenient and simple.

As shown in FIG. 7 and FIG. 8, according to some embodiments of the present application, the second end 122B is provided with a communication port 123B, and the communication port 123B communicates with the first mount base 130B. A part of the filter cartridge 210B or the water path plate 220B may be threaded through the communication port 123B to connect the filter cartridge 210B and the water path plate 220B, which may reduce the quantity and length of connect pipelines in the water purifier and simplify the internal structure of the water purifier. As shown in FIG. 6, the filter cartridge mount base 120B extends along a horizontal direction (the left-right direction as shown in FIG. 5). The first end 121B of the filter cartridge mount base 120B is connected to the enclose plate 110B, and the second end 122B is located inside the mount space; the first mount base 130B extends along the height direction of the housing assembly 100B (the up-down direction as shown in FIG. 5), and an end of the first mount base 130B is opposite to another end of the filter cartridge mount base 120B, which communicate with each other through the communication port 123B to facilitate the connection between the filter cartridge 210B and the water path plate 220B.

In some embodiments, the area of the communication port 123B is smaller than a cross-sectional area of the second end 122B, and a part of the housing of the filter cartridge mount base 120B located at the second end 122B may limit the filter cartridge 210B. As shown in FIG. 5, the height direction of the housing assembly 100B is the up-down direction as shown in the figure, and the extension direction of the filter cartridge mount base 120B is perpendicular to the height direction of the housing assembly 100B. The peripheral wall of the filter cartridge mount base 120B supports the filter cartridge 210B. As such, compared with supporting the entire filter cartridge 210B through the first end 121B or the second end 122B, the force on the filter cartridge mount base 120B may be optimizes and the stability of the filter cartridge 210B may be improved.

As shown in FIG. 6 and FIG. 7, according to some embodiments of the present application, the plurality of sub-plates further include a second plate body 113B, and the second plate body 113B is connected to the first mount base 130B and provided with a communication hole 114B. The water path plate 220B is provided with a water pipeline, and the quantity of the water pipelines may be plural. At least one water pipeline is configured to be connected to the water source to supply water to the water purifier, and at least one water pipeline is configured to discharge the waste water from the water purifier. The water pipeline of the water path plate 220B is threaded through the communication hole 114B to connect to an external system of the water purifier. A plurality of communication holes 114B may be provided, and each communication hole 114B corresponds to each water pipeline one by one.

As shown in FIG. 4 and FIG. 5, according to some embodiments of the present application, a plurality of filter cartridge mount bases 120B may be provided, each of which may accommodate a filter cartridge 210B. The length direction of each filter cartridge mount base 120B is perpendicular to the arrangement direction of the plurality of filter cartridge mount bases 120B. As shown in FIG. 5, the plurality of filter cartridge mount bases 120B are provided along the height direction of the housing assembly 100B (the up-down direction as shown in FIG. 5), and each filter cartridge mount base 120B extends along a horizontal direction (the left-right direction as shown in FIG. 5). Such arrangement may optimize the structure of the housing assembly 100B, reduce the volume of the housing assembly 100B, and reduce the volume of the water purifier. In the example of FIG. 4, there may be two filter cartridge mount bases 120B, and the water purifier may be provided with an RO filter cartridge and a PAC filter cartridge. The RO filter cartridge is provided inside one of the filter cartridge mount bases 120B, and the PAC filter cartridge is provided inside another filter cartridge mount base 120B.

According to some embodiments of the present application, the housing assembly 100B further includes a side plate, the side plate is connected to the enclose plate 110B, and the side plate is covered at the mount space for encapsulation, providing protection for the parts within the mount space. There may be two side plates, with one covering a side of the mount space and another covering another side of the mount space. The side plate and the enclose plate 110B may be connected through a screw, for example, an inner side of the enclose plate 110B is provided with a threaded hole, the side plate is provided with a through hole, and the side plate and the enclose plate 110B are connected through the screw. In an embodiment, the side plate and the enclose plate 110B may be snapped together, where the enclose plate 110B is integrally formed with a plurality of snap blocks through injection molding, and the plurality of snap blocks are distributed along the circumference of the mount space; and the side plate is provided with a plurality of snap slots, and the snap block is embedded into the snap slot, which fixedly connects the side plate and the enclose plate 110B.

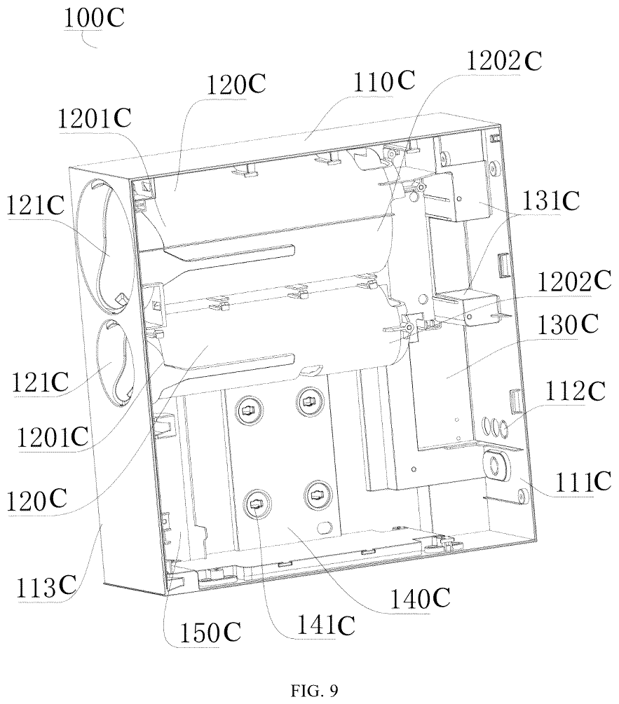

Below, a water purifier and a housing assembly thereof of the present application are described in conjunction with FIG. 9 to FIG. 12. An under sink water purifier is a type of water purifier mounted at the water supply terminal in the kitchen, which may provide clean water to every household. It is easy to mount, small in size, and does not take up much space. When in use, the faucet is simply turned on to obtain clean water, which is fast and convenient.

The water purifier according to the embodiments of the present application includes a housing assembly 100C, a filter cartridge, a water path plate, a booster pump, and a control panel.

In an embodiment, the housing assembly 100C may provide a mount position and an accommodation space to fix the filter cartridge, the water path plate, the booster pump, and the control panel. In side of the housing assembly 100C may be provided with a filter cartridge mount base 120C, a first mount base 130C, a second mount base 140C, and a third mount base 150C. The filter cartridge is configured to filter water. The filter cartridge may be an RO filter cartridge or a PAC filter cartridge. The type and quantity of filter cartridges may be selected based on the function of the water purifier. The filter cartridge is provided inside the filter cartridge mount base 120C of the housing assembly 100C and is fixedly connected to the filter cartridge mount base 120C. The water path plate may include a plurality of pipelines and valves, and may be connected to a water source to supply water to the water purifier. The water path plate may also discharge the waste water generated in the water purifier. The water path plate is connected to and communicates with the filter cartridge, and water enters the filter cartridge through the water path plate for filtration, and then is provided to the user. The water path plate is provided inside the first mount base 130C of the housing assembly 100C and is fixedly connected to the first mount base 130C.

The booster pump is connected to and communicates with the pipeline at the water path plate. The booster pump is configured to increase the pressure of water to drive the water to flow smoothly in the water purifier. The booster pump is provided inside the second mount base 140C of the housing assembly 100C and is fixedly connected to the second mount base 140C. The control panel is provided inside the third mount base 150C of the housing assembly 100C and is fixedly connected to the third mount base 150C. The control panel is connected to the booster pump to adjust the work state of the booster pump, which regulates the water flow rate inside the water purifier.

As shown in FIG. 9, the housing assembly 100C of the water purifier according to the embodiments of the present application includes an enclose plate 110C, a filter cartridge mount base 120C, a first mount base 130C, a second mount base 140C, and a third mount base 150C.

In an embodiment, the filter cartridge mount base 120C accommodates and fixes the filter cartridge; the first mount base 130C accommodates and fixes the water path plate; the second mount base 140C accommodates and fixes the booster pump; the third mount base 150C accommodates and fixes the control panel. The enclose plate 110C forms a mount space, and the filter cartridge mount base 120C, the first mount base 130C, the second mount base 140C, and the third mount base 150C are provided inside the mount space. That is, the filter cartridge mount base 120C, the first mount base 130C, the second mount base 140C, and the third mount base 150C may be integrated inside the enclose plate 110C to improve the integration of the water purifier and reduce the volume of the water purifier.

At least two of the enclose plate 110C, the filter cartridge mount base 120C, the first mount base 130C, the second mount base 140C, and the third mount base 150C are integrally formed as integrated members, which reduces the quantity of components of the housing assembly 100C, and reduces production steps and required production machines to reduce costs. The reduction of the components simplifies the assembly steps of the housing assembly 100C and improves the production efficiency. For example, the enclose plate 110C and the filter cartridge mount base 120C may be integrally formed through injection molding, that is, the enclose plate 110C and the filter cartridge mount base 120C may be simultaneously formed through a single injection molding process to form an integrated member. In an embodiment, the first mount base 130C, the second mount base 140C, and the third mount base 150C may be integrally formed through injection molding, that is, the first mount base 130C, the second mount base 140C, and the third mount base 150C may be simultaneously formed through a single injection molding process to form an integrated member. In an embodiment, the enclose plate 110C, the filter cartridge mount base 120C, the first mount base 130C, the second mount base 140C, and the third mount base 150C may be integrally formed through injection molding, and the enclose plate 110C, the filter cartridge mount base 120C, the first mount base 130C, the second mount base 140C, and the third mount base 150C are formed as an integrated member. As such, the assembly of each part is omitted, the assembly steps are simplified, the production costs are reduced, and the production efficiency is improved.

In the housing assembly 100C according to the embodiments of the present application, at least two of the enclose plate 110C, the filter cartridge mount base 120C, the first mount base 130C, the second mount base 140C, and the third mount base 150C are integrally formed into an integrated member, which reduces the quantity of components of the housing assembly 100C, reduces production steps and required production machines, reduces costs, simplifies the assembly steps of the housing assembly 100C, and improves the production efficiency.

As shown in FIG. 9, according to some embodiments of the present application, the filter cartridge mount base 120C includes a first end 1201C and a second end 1202C. The first end 1201C is provided with a mount port 121C, where the mount port 121C is used for mounting or disassembling the filter cartridge. The mount port 121C may be integrally formed at the filter cartridge mount base 120C, or may be formed at the first end 1201C after the filter cartridge mount base 120C is formed. As shown in FIG. 9, the filter cartridge mount base 120C is cylindrical in shape to fit the shape of the filter cartridge. An end of the cylindrical filter cartridge mount base 120C is the first end 1201C, and another end is the second end 1202C. A mount port 121C is provided at the first end 1201C. A peripheral wall of the filter cartridge mount base 120C may fix and support the filter cartridge to improve the stability of mounting of the filter cartridge. Users may plug the filter cartridge into the filter cartridge mount base 120C through the mount port 121C, or remove the filter cartridge from the mount port 121C for replacement.

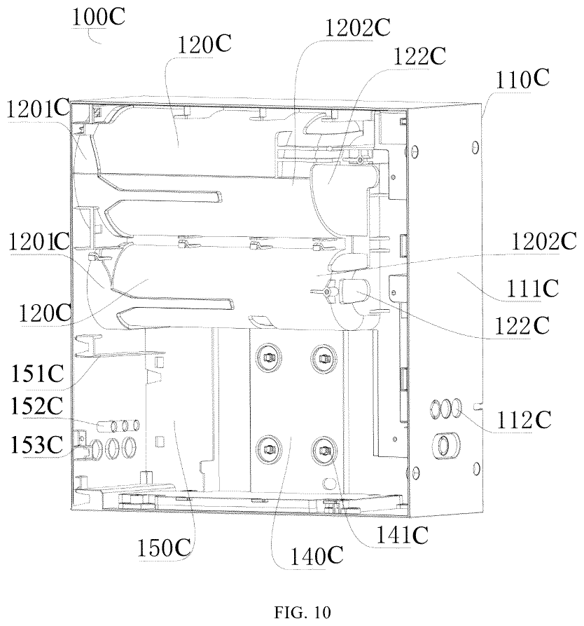

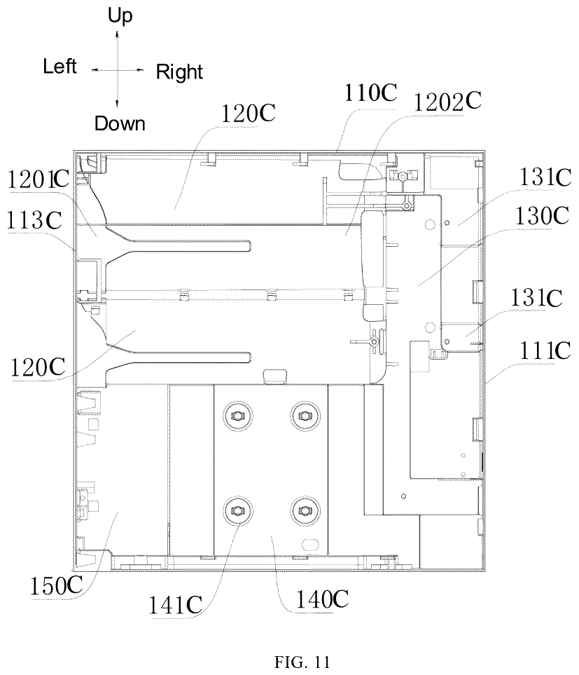

As shown in FIG. 10, according to some embodiments of the present application, the second end 1202C is provided with a connection port 122C, and at least a part of the first mount base 130C is located at the second end 1202C of the filter cartridge mount base 120C. The connection port 122C communicates the filter cartridge mount base 120C and the first mount base 130C, and a part of the filter cartridge or the water path plate may be threaded through the connection port 122C to connect the filter cartridge and the water path plate, which may reduce the quantity and length of the connect pipelines in the water purifier and simplify the internal structure of the water purifier. As shown in FIG. 11, the filter cartridge mount base 120C extends along a horizontal direction (the left-right direction as shown in FIG. 11), the first end 1201C of the filter cartridge mount base 120C is connected to the enclose plate 110C, and the second end 1202C is located inside the mount space; and the first mount base 130C extends along a height direction of the housing assembly 100C (the up-down direction as shown in FIG. 11), and an end of the first mount base 130C is opposite to another end of the filter cartridge mount base 120C, and communicates with the another end of the filter cartridge mount base 120C through the connection port 122C, to facilitate the connection between the filter cartridge and the water path plate.

In some embodiments, an area of the connection port 122C is smaller than a cross-sectional area of the second end 1202C, and a part of the housing of the filter cartridge mount base 120C located at the second end 1202C may limit the filter cartridge. As shown in FIG. 11, the height direction of the housing assembly 100C is the up-down direction as shown in the figure. The extension direction of the filter cartridge mount base 120C is perpendicular to the height direction of the housing assembly 100C. The peripheral wall of the filter cartridge mount base 120C supports the filter cartridge. As such, compared with supporting the entire filter cartridge through the first end 1201C or the second end 1202C, the force on the filter cartridge mount base 120C may be optimized and the stability of the filter cartridge may be improved.

As shown in FIG. 9, according to some embodiments of the present application, a plurality of filter cartridge mount bases 120C are provided, and each filter cartridge mount base 120C may accommodate a filter cartridge. The length direction of each filter cartridge mount base 120C is perpendicular to the arrangement direction of the plurality of filter cartridge mount bases 120C. As shown in FIG. 11, a plurality of filter cartridge mount bases 120C are arranged along the height direction of the housing assembly 100C (the up-down direction as shown in FIG. 11), and each filter cartridge mount base 120C extends along a horizontal direction (the left-right direction as shown in FIG. 11). This arrangement may optimize the structure of the housing assembly 100C, reduce the volume of the housing assembly 100C, and reduce the volume of the water purifier. There may be two filter cartridge mount bases 120C, and the water purifier may be provided with an RO filter cartridge and a PAC filter cartridge. The RO filter cartridge is provided inside one of the filter cartridge mount bases 120C, and the PAC filter cartridge is provided inside another filter cartridge mount base 120C.

As shown in FIG. 9, according to some embodiments of the present application, the bottom wall of the first mount base 130C is provided with a plurality of support blocks 131C, where the support blocks 131C may fix and support the water path plate to align the pipelines at the water path plate with the filter cartridge for connection. The support block 131C is connected to the water path plate, and may be connected to the water path plate through a screw. A plurality of the support blocks 131C may be provided, and the plurality of support blocks 131C are provided at intervals to form a snap-fix position between the fix blocks 131C. Part of structures of the water path plate may be located in the snap-fix position to fix the water path plate. In some embodiments, the support block 131C may be a hollow structure with a reinforcement rib provided inside to reduce the weight of the first mount base 130C, and another end of the support block 131C is open for forming.

As shown in FIG. 9 and FIG. 11, according to some embodiments of the present application, the bottom wall of the second mount base 140C is provided with a plurality of plug holes 141C, where the plug holes 141C are through holes. At least part of the booster pump is plugged into the plug holes 141C to fix the booster pump. The booster pump may be provided with a plug member, where the plug member is plugged into the plug hole 141C. During assembly, the plug member is aligned with the plug hole 141C and plugged into the plug hole 141C, and then the plug member is fixed in the plug hole 141C. For example, the plug member may be a bolt, the plug hole 141C may be a threaded hole, or the plug hole 141C may be embedded with a nut, and after being plugged into the plug hole 141C, the bolt may be screwed tightly to fix the booster pump. Both a plurality of the plug holes 141C and a plurality of the plug members may be provided, and both the plug holes 141C and the plug members are provided in array. Each plug member corresponds to each plug hole 141C one by one, to fix the booster pump from a plurality of directions and avoid loosening or displacement of the booster pump during operation.

As shown in FIG. 10, according to some embodiments of the present application, the third mount base 150C is provided with a first side wall, and the first side wall is provided with a fix plate 151C. The fix plate 151C limits the control panel, and the fix plate 151C abuts against and limit the control panel. For example, the third mount base 150C is further provided with a second side wall, where the second side wall is connected to the first side wall and may be perpendicular to the first side wall. The fix plate 151C extends along a depth direction of the third mount base 150C, with a side of the fix plate 151C facing the second side wall. A fix space is formed between the fix plate 151C and the second side wall, and the control panel is accommodated inside the fix space. The control panel may be slightly larger than the fix space. A side of the control panel abuts against the fix plate 151C, another side of the control panel abuts against the second side wall. As such, the control panel may be stably mounted in the third mount base 150C.

As shown in FIG. 10, according to some embodiments of the present application, the first side wall is further provided with a plurality of fix columns 152C, and the fix column 152C abuts against the control panel, to limit the control panel. A plurality of fix columns 152C may be provided, and distribution of the fix columns 152C is related to distribution of components at the control panel. The fix column 152C should avoid compressing the components at the control panel. In some embodiments, the first side wall is further provided with a connection rib 153C, where the connection rib 153C is fixedly connected to the control panel, for example, through a screw.

As shown in FIG. 9, according to some embodiments of the present application, the opening of the accommodation space formed by the first mount base 130C is configured to mount or disassemble the water path plate, the opening of the accommodation space formed by the second mount base 140C is configured to mount or disassemble the booster pump, and the opening of the accommodation space formed by the third mount base 150C is configured to mount or disassemble the control panel. The opening of the accommodation space formed by the first mount base 130C, the opening of the accommodation space formed by the second mount base 140C, and the opening of the accommodation space formed by the third mount base 150C all face a side of the mount space. In this way, during assembly, the water path plate, the booster pump, and the control panel may be mounted one by one from a side of the mount space, without the need to flip the housing assembly 100C a plurality of times, which greatly improves assembly efficiency and reduces the risk of component damage during assembly.

As shown in FIG. 9, according to some embodiments of the present application, the enclose plate 110C includes a plurality of sub-plates, the plurality of sub-plates are connected in sequence to form the mount space. The filter cartridge mount base 120C, the first mount base 130C, the second mount base 140C, and the third mount base 150C are all located inside the mount space, and the filter cartridge mount base 120C, the first mount base 130C, the second mount base 140C, and the third mount base 150C may all be connected to the sub-plate. As shown in FIG. 9, the enclose plate 110C may include four sub-plates, and the four sub-plates are connected in sequence to form a rectangular mount space. A part of structures of the enclose plate 110C constitutes part of side walls of the first mount base 130C, the second mount base 140C, and the third mount base 150C. The mount space has two opposite side surfaces with largest areas. The opening of the accommodation space formed by the first mount base 130C, the opening of the accommodation space formed by the second mount base 140C, and the opening of the accommodation space formed by the third mount base 150C all face one of the side surfaces. The bottom wall of the first mount base 130C, the bottom wall of the second mount base 140C, and the bottom wall of the third mount base 150C all face another of the side surfaces. It should be noted that this is only an embodiment and does not limit the quantity of sub-plates or the shape of the mount space. The quantity of sub-plates may also be 5, 6, or 7, etc.

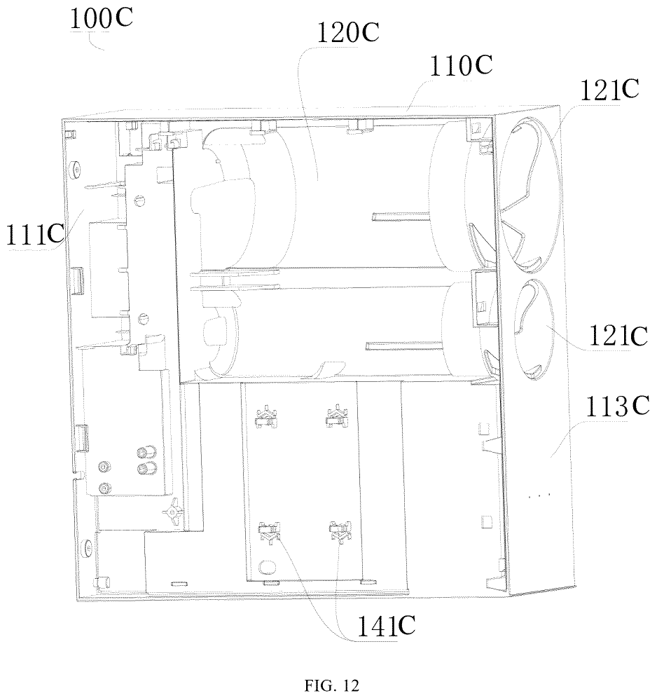

As shown in FIG. 10 and FIG. 12, in some embodiments, the enclose plate 110C protrudes from the bottom wall of the first mount base 130C, the second mount base 140C, or the third mount base 150C. That is, the enclose plate 110C protrudes from the bottom wall of the first mount base 130C in an opposite direction to the opening of the accommodation space formed by the first mount base 130C. In an embodiment, the enclose plate 110C protrudes from the bottom wall of the second mount base 140C in an opposite direction to the opening of the accommodation space formed by the second mount base 140C. In an embodiment, the enclose plate 110C protrudes from the bottom wall of the third mount base 150C in an opposite direction to the opening of the accommodation space formed by the third mount base 150C. Thus, a certain accommodation space is formed at the bottom wall of the first mount base 130C, the second mount base 140C, or the third mount base 150C in the direction away from the corresponding opening, to accommodate cables or other parts inside the water purifier.

As shown in FIG. 9 and FIG. 10, according to some embodiments of the present application, the sub-plate connected to the first mount base 130C among the plurality of sub-plates is the first plate body 111C, where the first plate body 111C is provided with a communication hole 112C. The water path plate is provided with a water pipeline, and the quantity of the water pipelines may be plural. At least one water pipeline is configured to be connected to the water source to supply water to the water purifier, and at least one water pipeline is configured to discharge the waste water from the water purifier. The water pipeline of the water path plate is threaded through the communication hole 112C to connect to an external system of the water purifier. A plurality of communication holes 112C may be provided, and each communication hole 112C corresponds to each water pipeline one by one.

As shown in FIG. 9 and FIG. 12, according to some embodiments of the present application, the plurality of sub-plates include a second plate body 113C, where the second plate body 113C is connected to the filter cartridge mount base 120C and is provided with a communication hole. The communication hole communicates with the mount port 121C of the filter cartridge mount base 120C, and the filter cartridge may be mounted or removed through the communication hole. In this way, when replacing the filter cartridge, there is no need to disassemble the enclose plate 110C, and the filter cartridge may be mounted by plugging through the communication hole, which is convenient and simple.

In the related art, when assembling the water purifier, it is necessary to mount the above-mentioned parts at the base body, and the base body may bear the above-mentioned parts. After the assembly of the components is completed by the staff, an exterior panel is then placed at the outside of the base body to form a complete water purifier. During the assembly of a typical water purifier in production line, workers generally need to flip the base body a plurality of times, screw or fasten various components from different directions at two sides of the base body, which increases the workload of the workers. And during flipping of the base body, it is easy to cause damage to the base body or components, which results in low production efficiency.

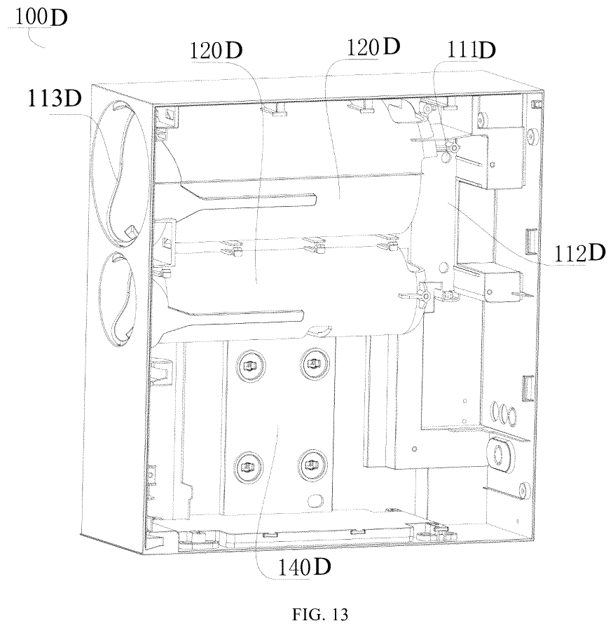

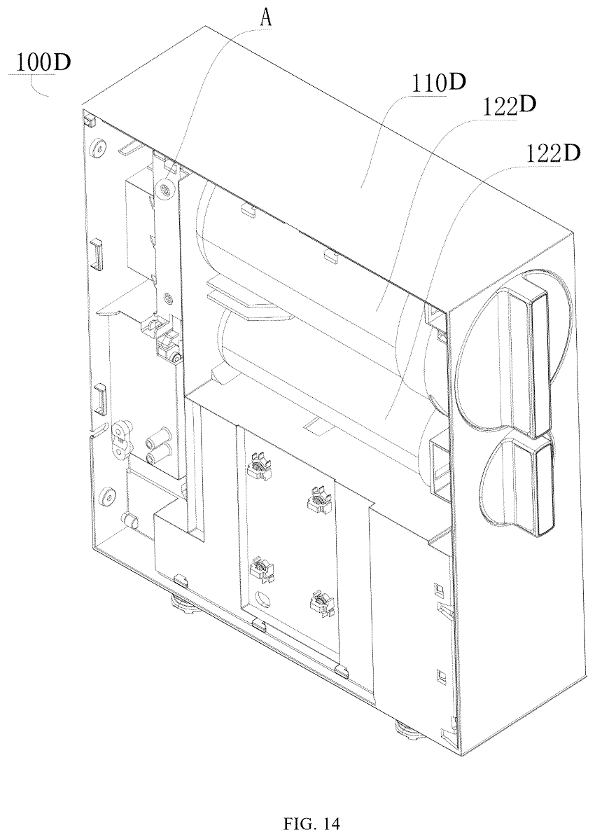

Below, a water purifier 100D according to the embodiments of the present application is introduced through FIG. 13 to FIG. 19.

As shown in FIG. 13 to FIG. 15, the present application provides a water purifier 100D, including a base body 110D, a filter cartridge support base 120D, and a water path plate 130D. The base body 110D is provided with a plug slot 112D, the filter cartridge support base 120D is provided at the base body 110D, and the filter cartridge support base 120D is provided at a side of the plug slot 112D. The water path plate 130D is plugged into the plug slot 112D, and is fixedly connected to the filter cartridge support base 120D. In this way, when assembling the water purifier 100D, the water path plate 130D may be mounted at the same side of the filter cartridge support base 120D, which reduces the quantity of times the base body 110D needs to be flipped.

In this way, the assembly efficiency and production convenience of the staff when assembling the water purifier 100D are improved, the time consumption during assembly of the water purifier 100D is reduced, and the labor intensity is lowered. Due to the fact that the water path plate 130D and the filter cartridge support base 120D are located at the same side, assembly personnel may complete the mounting of all related assemblies at a relatively fixed position, which reduces the need for moving and adjusting works places. This one-side integrated design is also beneficial for subsequent maintenance and replacement of filter cartridge 122D, as users or maintenance personnel may have more intuitive and convenient access to the core assemblies for cleaning or replacement.

The water purifier 100D provided in the present application integrates the base body 110D, the filter cartridge support base 120D, and the water path plate 130D in an artful design. By providing a slot for plugging at the base body 110D, the filter cartridge support base 120D may be easily positioned at a side of the base body 110D and the water path plate 130D may be smoothly plugged at the same side. This design allows the water path plate 130D to be directly plugged along the plug slot 112D and fixedly connected to the base body 110D during assembly of the water purifier 100D, which avoids the tedious steps of repeatedly flipping and rotating the base body 110D to adapt to assembly positions of different components. In addition, by reducing the quantity of flips of the base body 110D during assembly, the risk of accidental damage to the assemblies during assembly is correspondingly reduced, which improves the overall reliability of the product.

As shown in FIG. 13 to FIG. 15, in an embodiment of the present application, the water path plate 130D is provided with at least one first plug member 131D, and the base body 110D is provided with at least one second plug member 111D. The first plug member 131D and the second plug member 111D may be detachably plugged and matched. The first plug member 131D is a plug hole, and the second plug member 111D is a limit rib. In other embodiments, the first plug member 131D is a limit rib, and the second plug member 111D is a plug hole.

Such plugging and matching simplify the assembly, as the water path plate 130D and the base body 110D may be quickly connected or separated through intuitive pushing or pulling actions, which significantly improves the assembly efficiency. In addition, this design ensures the stability and precise position of the water path plate 130D after assembly. Due to the fact that the limit rib may be firmly embedded in the plug hole, the sealing and reliability of the water path system are ensured, which improves the overall performance and durability of the water purifier 100D.

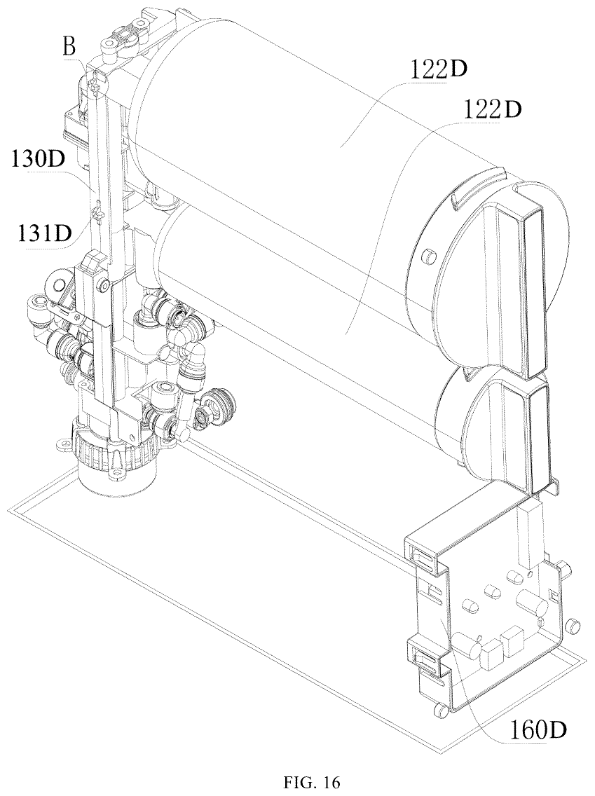

As shown in FIG. 16, in some embodiments of the present application, a plurality of first plug members 131D are provided, and the first plug members 131D are provided at intervals at the water path plate 130D. In this way, the connect stability between the water path plate 130D and the base body 110D may be enhanced, and the distributed plug members may uniformly bear a fix force, which improves the anti-torsion and anti-vibration ability of the entire assembly structure of the water purifier 100D. The first plug members 131D at intervals also help ensure precise alignment of the water path plate 130D with the base body 110D at a plurality of points. In addition, due to the distributed design of a plurality of plug members, even if one of the plug members is damaged or fails, other plug members may still maintain the overall connection, which improves the reliability and durability of the product.

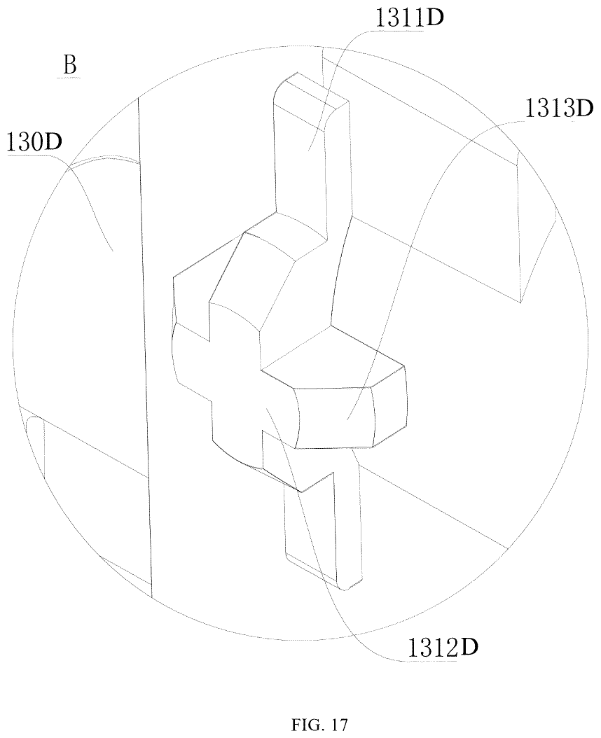

As shown in FIG. 16 and FIG. 17, in some embodiments of the present application, the limit rib includes a strip section 1311D and a plug section 1312D. The strip section 1311D protrudes from the surface of the water path plate 130D, and a length of the strip section 1311D is greater than a diameter of the limit hole. The plug section 1312D and the strip section 1311D are integrally formed, and the plug section 1312D is located inside the limit hole. In this way, during assembly, the strip section 1311D may provide a larger contact area, to provide a tightly fit with the base body 110D, which increases the stability of plugging between the water path plate 130D and the base body 110D. In addition, the plug section 1312D may be accurately plugged into the limit hole at the base body 110D, which ensures the firmness and precise alignment of the connection between the water path plate 130D and the base body 110D. Moreover, due to the length of the strip section 1311D exceeding the diameter of the limit hole, when the water path plate 130D is subjected to external forces such as pushing, pulling, or twisting, the strip section 1311D may provide additional resistance, which enhances the overall durability and stability of the structure of the water purifier 100D. At the same time, this integrated limit rib reduces the quantity of parts between the water path plate 130D and the base body 110D, simplifies the manufacturing and assembly, and reduces costs.

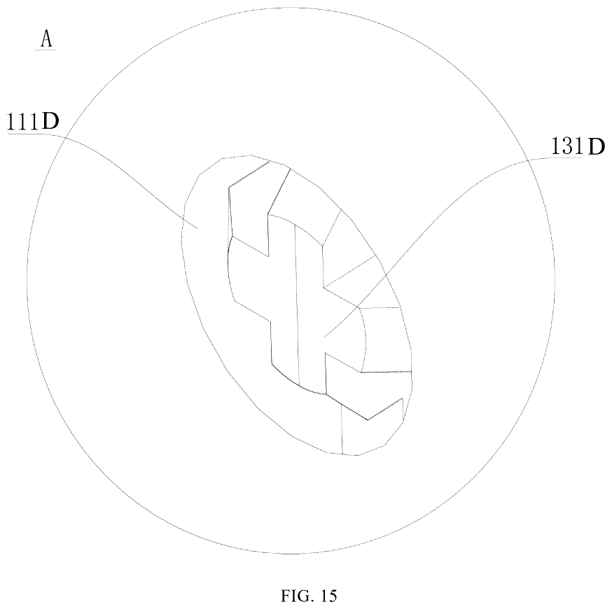

As shown in FIG. 15 and FIG. 17, in some embodiments of the present application, the cross-section of the plug section 1312D is a “+” shape. Due to the four raised edges in the cross-section of the “+” shape, when the plug section 1312D is plugged into the corresponding limit hole, these raised edges may provide more friction and connect area, which increases the firmness and stability of the connection between the plug section 1312D and the limit hole. This design may prevent the plug section 1312D from rotating or shifting during use, which ensures the reliability and safety of the connection. In addition, the design of the “+” cross-section may also reduce the risk of loosening or detachment of the plug section 1312D due to vibration or other external forces, prolong the service life of the water purifier 100D, and reduce maintenance frequency.

As shown in FIG. 17, in some embodiments of the present application, an end face of a free end of the plug section 1312D is provided with a cut slope 1313D. In this way, the cut slope 1313D may reduce the frictional resistance between the plug section 1312D and the limit hole, which makes the plugging and disassembling between the plug section 1312D and the limit hole smoother and easier. This design may also reduce the wear caused by friction at the plug section 1312D and prolong the service life of the plug section 1312D.

As shown in FIG. 13, in some embodiments of the present application, the opening of the plug slot 112D is provided towards a side of the base body 110D, and the peripheral wall of the base body 110D is provided with a mount port 113D. The mount port 113D communicates with the mount base of the filter cartridge 122D. When assembling the components of the water purifier 100D, the filter cartridge 122D may be mounted into the mount base of the filter cartridge 122D through the mount port 113D, and then the water path plate 130D may be directly plugged into the plug slot 112D, which avoids the need to flip the base body 110D during assembly. This design improves the efficiency of assembly, reduces the time consumption and labor of workers during operation, and may further reduce the potential risk of damage to the components of the water purifier 100D caused by flipping the water purifier 100D during assembly.

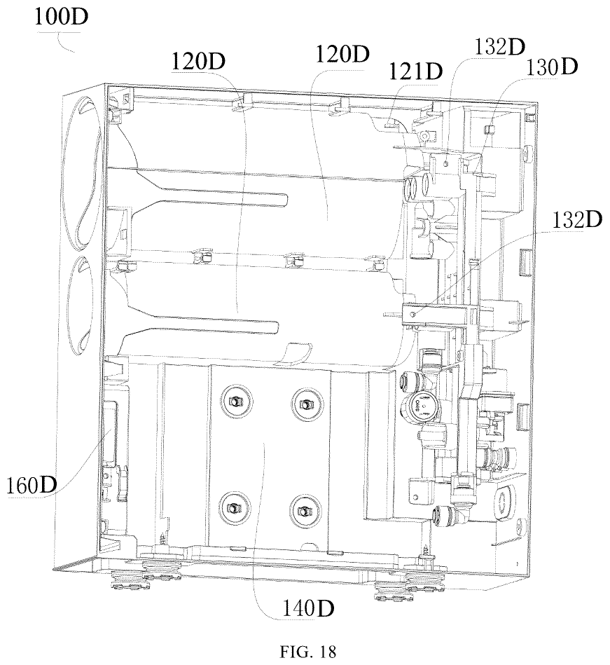

As shown in FIG. 13 and FIG. 18, in some embodiments of the present application, an end of the filter cartridge support base 120D facing the water path plate 130D is provided with a hollow part 121D, and the filter cartridge 122D is connected to the water path plate 130D at the hollow part 121D. The design of the hollow part 121D provides clear mount direction for the assembly of the filter cartridge 122D, simplifies the mounting of the filter cartridge 122D, and enables the filter cartridge 122D to accurately dock with the water path plate 130D. In addition, as the filter cartridge 122D is directly connected to the water path plate 130D, the quantity and complexity of parts of the entire water purifier 100D are reduced, which is beneficial for reducing costs and improving the product reliability. This design also facilitates users to easily find the connect point when replacing the filter cartridge 122D, which improves the convenience and maintenance efficiency of users when replacing the filter cartridge 122D.

In some embodiments of the present application, the base body 110D is provided with at least one reserve port, where the reserve port may be used to access a reserve water path. This design layout allows the water purifier 100D to flexibly expand or upgrade the water system, and allows for the addition of additional filtration modules or connection to other water treatment device based on needs of the user or new technical standards in subsequent use. In addition, the design of the reserve port may further provide customized solutions for special applications or regional needs, such as adding reserve water paths to address specific water quality issues or for specific filtration goals.

By providing reserve ports instead of directly fixing all possible water path configurations in the initial design, it also helps to reduce the initial cost of the water purifier 100D, and retain the possibility of upgrading the water purifier 100D during subsequent use.

In some embodiments of the present application, as shown in FIG. 13, the filter cartridge support base 120D and the base body 110D are integrally formed. In this way, the overall stability of the water purifier 100D is enhanced, and since there are no seams or connect parts between the filter cartridge support base 120D and the base body 110D, the possibility of overall structural looseness or leakage of the water purifier 100D is reduced. This design simplifies the production, eliminates the need to assemble the filter cartridge support base 120D separately from the base body 110D, helps reduce production time and manufacturing costs, and lowers the risk of product defects caused by assembly issues. Finally, the integrated design also facilitates cleaning and maintenance for users, reduces the gap accumulating dirt and facilitates the maintenance of product hygiene.

As shown in FIG. 13 and FIG. 18, in some embodiments of the present application, the base body 110D is provided with a pump body mount slot 140D, and an opening direction of the pump body mount slot 140D is the same as an opening direction of the plug slot 112D. In this way, the booster pump 150D and the water path plate 130D may be mounted at the same side of the base body 110D, which further reduces the quantity of times the base body 110D being flipped or rotated during assembly, simplifies the assembly steps and accelerates the assembly speed. The consistent opening direction also allows assembly line workers to complete the mount task of assembly of the base body 110D at the same operating surface, which reduces the labor intensity of workers.

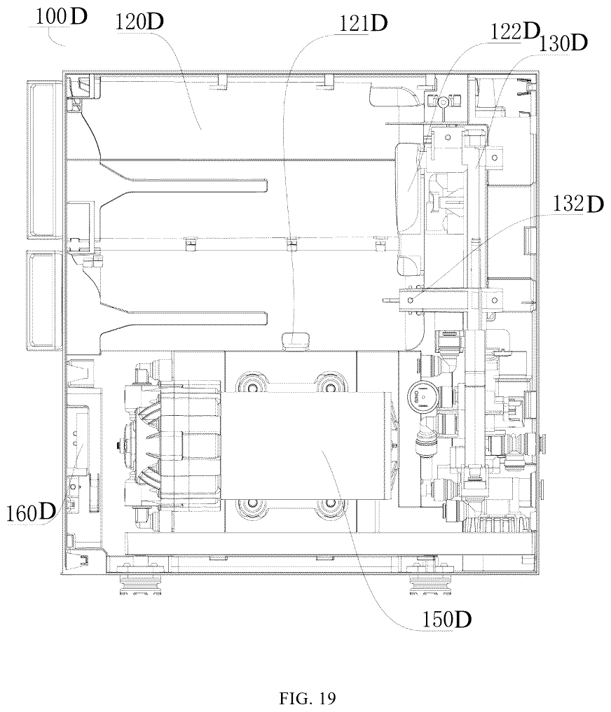

As shown in FIG. 19, in some embodiments of the present application, the base body 110D is further provided with a control panel mount slot (not shown in the figures), and the control panel assembly 160D is provided inside the control panel mount slot, and an opening direction of the control panel mount slot is the same as the opening direction of the plug slot 112D. In this way, the control panel assembly 160D, the water path plate 130D and the booster pump 150D may be mounted at the same side of the base body 110D, which further reduces the quantity of times the base body 110D being flipped or rotated during assembly, simplifies the assembly steps and accelerates the assembly speed. The consistent opening direction also allows assembly line workers to complete the mount task of assembly of the base body 110D at the same operating surface, which reduces the labor intensity of workers.

As shown in FIG. 18 and FIG. 19, in some embodiments of the present application, the water path plate 130D is provided with a threaded hole 132D, and the water path plate 130D is detachably connected to the filter cartridge support base 120D through the match of the bolt and the threaded hole 132D. In this way, the stability of the mounting of the water path plate 130D may be further ensured, which prevents the water path plate 130D from falling off from the plug slot 112D during the operation of the water purifier 100D.

The mounting of the water purifier 100D provided in the present application is introduced based on FIG. 13 to FIG. 19. Firstly, the filter cartridge 122D is mounted into the filter cartridge support base 120D from the mount port 113D, and then the booster pump 150D, the water path plate 130D, and the control panel assembly 160D are mounted at the same side of the base body 110D. In this way, when assembling the water purifier 100D, there is no need to flip the base body 110D, which makes the mounting faster and easier.

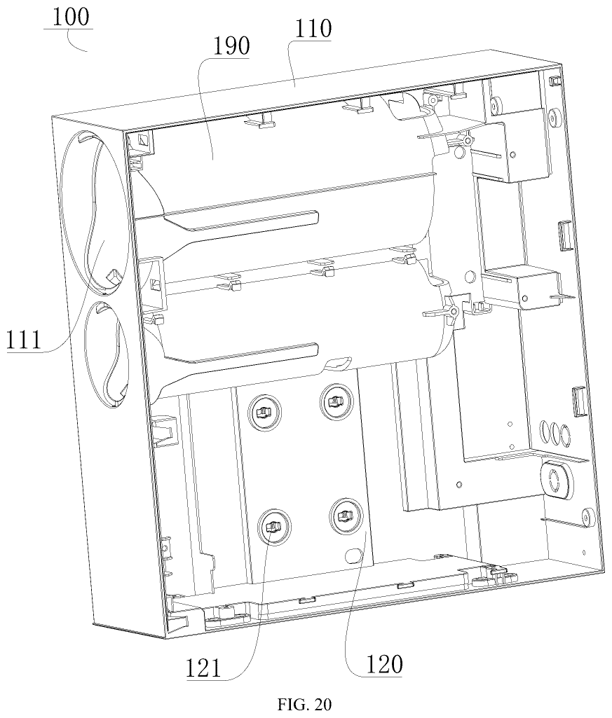

Below, a water purifier 100 according to the embodiments of the present application is introduced based on FIG. 20 to FIG. 26.

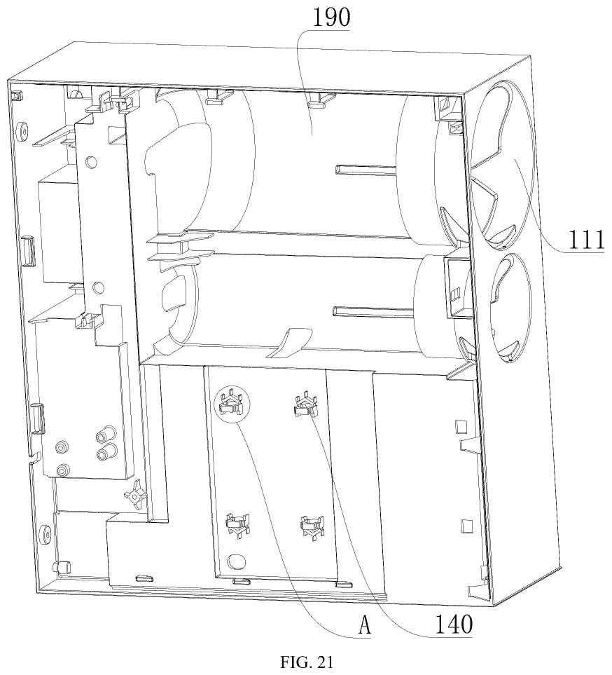

As shown in FIG. 20 and FIG. 21, the present application provides a water purifier 100, including a base body 110 and a pump body mount base 120. The pump body mount base 120 is provided with a mount hole 121, and a booster pump 130 is provided at a side of the pump body mount base 120. Another side of the pump body mount base 120 is provided with a fix base 140, where the fix base 140 is covered at the mount hole 121. The booster pump 130 is connected to the pump body mount base 120 through a bolt 150, where the bolt 150 is threaded through the mount hole 121, and the fix base 140 is covered at a part of structures of the bolt 150. The base body 110, the pump body mount base 120, and the fix base 140 are all made of shock-absorbing plastic. The fix base 140 contacts the bolt 150, which increases the contact surface of the bolt 150 and reduces the transmission efficiency of vibration.

According to the water purifier 100 of the embodiments of the present application, by providing another side of the pump body mount base 120 with the fix base 140, where the fix base 140 is covered at the mount hole 121, when the water purifier 100 is working, the vibration generated by the booster pump 130 is first transmitted to the pump body mount base 120. Due to the presence of the bolt 150 and the fix base 140, the vibration is dispersed and transmitted to the bolt 150 and the fix base 140. This dispersion may reduce the intensity of vibration directly transmitted to the base body 110, which reduces the noise generated during the operation of the booster pump 130. The combination of the bolt 150 and the fix base 140 improves the stability of the mount structure of the booster pump 130 in the water purifier 100, which also helps to reduce the transmission of vibration generated by the booster pump 130.

As shown in FIG. 21, in some embodiments of the present application, the fix base 140 includes a base main body 141 and a connection beam 142. The base main body 141 protrudes from a surface of the pump body mount base 120 and is provided around the mount hole 121 along a circumferential direction of the mount hole 121, which increases the contact area between the fix base 140 and the pump body mount base 120, allows the fix base 140 to more evenly bear and disperse the vibration caused by the booster pump 130, and reduces the direct transmission of vibration energy to the base body 110.

The connection beam 142 and the base main body 141 are integrally formed, and the connection beam 142 spans at a free end of the base main body 141, and is opposite to the mount hole 121. In this way, the connection beam 142 may act as a “cantilever beam” when receiving vibration, which may absorb and attenuate some of the vibration energy, and reduce the impact of vibration at the base body 110. In addition, the connection beam 142 and the base main body 141 are integrally formed and have a certain length and elasticity, which allows the connection beam 142 to work like a spring, with a certain isolation and damping effect, prevents the propagation and amplification of vibration waves, and produces a buffering effect on the vibration of the booster pump 130.

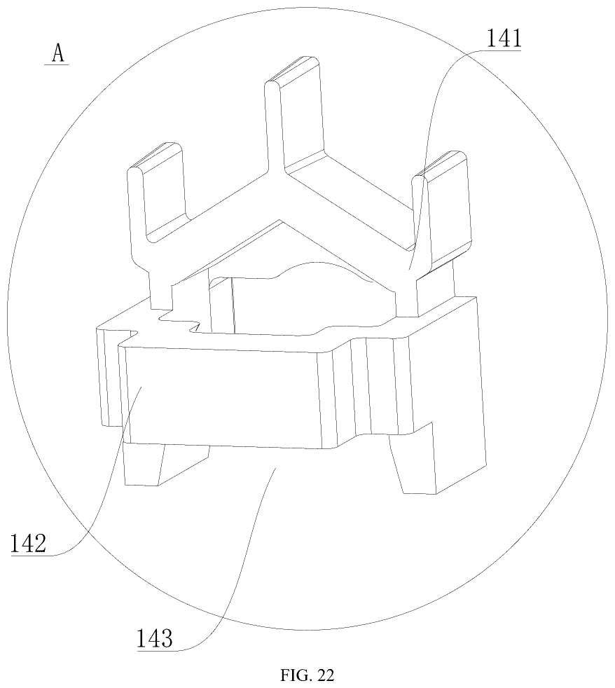

As shown in FIG. 22, in some embodiments of the present application, the base main body 141 is provided with a notch 143, where the notch 143 communicates with the mount hole 121. The notch 143 provides a space for conveniently adjusting the bolt 150, which makes it easier for personnel to mount or disassemble the booster pump 130. In addition, the booster pump 130 generates heat during operation, and the base main body 141 and the bolt 150 may experience structural tension due to thermal expansion. The notch 143 may provide a certain thermal expansion space for the bolt 150, which avoids stress concentration and structural damage at the fix base 140 and the bolt 150 caused by temperature changes. In addition, by providing the notch 143 at the base main body 141, the amount of material used for the fix base 140 may be reduced without sacrificing the structural integrity and stability of the fix base 140, which may reduce production costs.

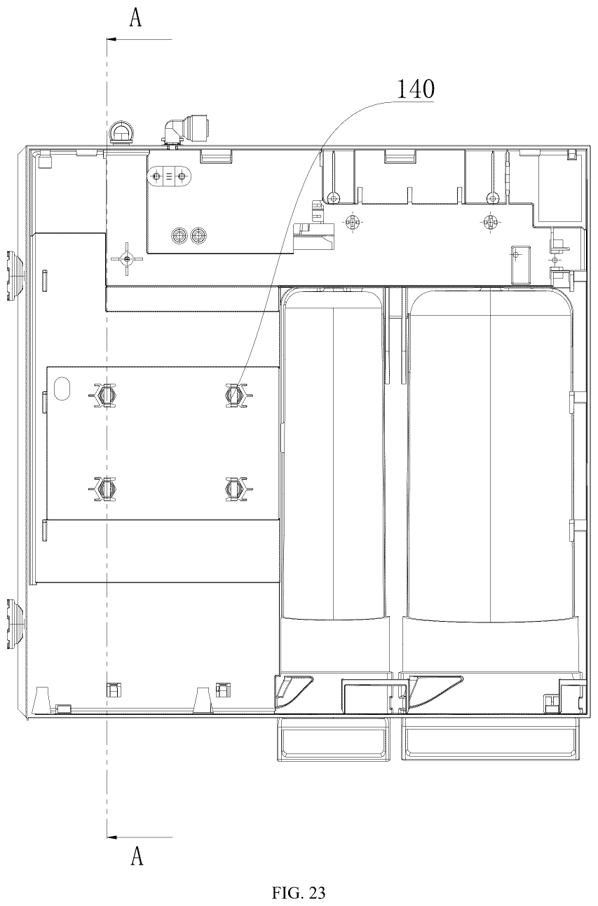

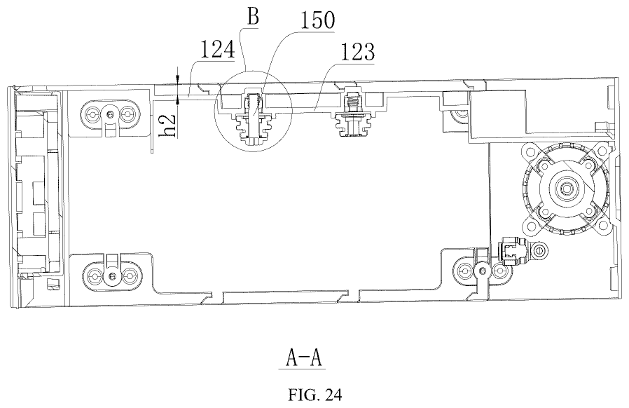

As shown in FIG. 23 and FIG. 24, in some embodiments of the present application, the bolt 150 is sleeved with a nut 160, and an end face of the bolt 150 is in contact with the connection beam 142. A peripheral wall of the nut 160 is in contact with the base main body 141. This close contact ensures the stability of the structure between the bolt 150 and the fix base 140. When vibration occurs in the booster pump 130, the bolt 150 and the nut 160 may directly transfer the vibration energy to the connection beam 142 and the base main body 141, which absorbs and disperses the vibration energy and reduces the noise generated by the booster pump 130. In addition, the bolt 150 and the nut 160 in close contact with the fix base 140 help maintain accurate alignment of the entire device and prevent displacement of parts such as the bolt 150 and the nut 160 due to vibration.

In other embodiments of the present application, there is a gap between the end face of the bolt 150 and the connection beam 142, and there is a gap between the peripheral wall of the nut 160 and the base main body 141. The gap provides a certain amount of move space, which allows bolt 150 and nut 160 to move within the range of the move space instead of immediately transmitting vibration, which reduces the vibration transmitted to the base body 110. In addition, the presence of gaps may compensate for the thermal expansion and contraction of the bolt 150 and the nut 160, which prevents stress concentration caused by temperature changes in the fix base 140, the bolt 150, and the nut 160. In long-term use and vibration environments, the gap may reduce the tighten force requirements for the bolt 150 and the nut 160, prevent damage to the bolt 150 and the nut 160 caused by excessive tightening, and improve the durability and reliability of the device.

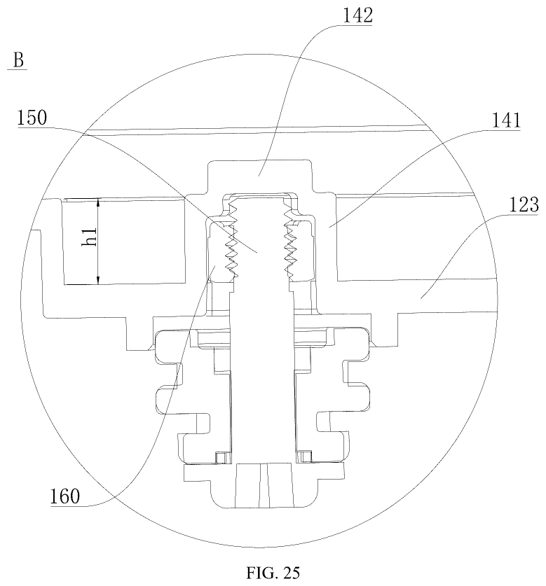

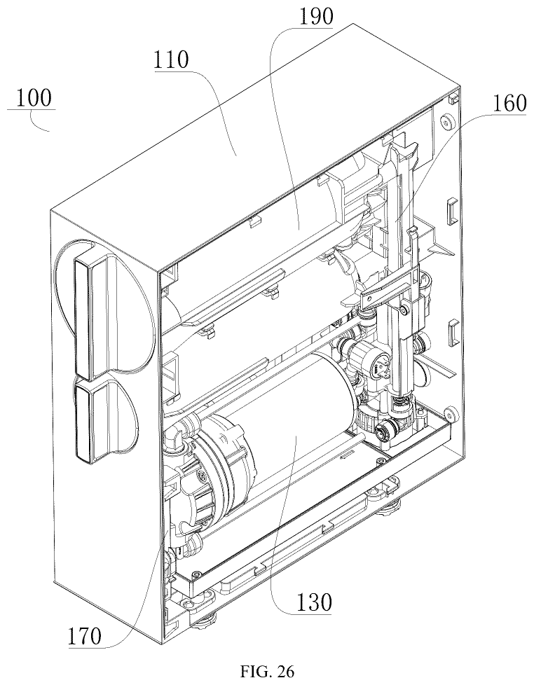

As shown in FIG. 20, FIG. 24, FIG. 25, and FIG. 26, in some embodiments of the present application, the pump body mount base 120 is provided with a mount slot 122, and the booster pump 130 is provided inside the mount slot 122. A bottom wall of the mount slot 122 is provided with a first protrusion 123, and the mount hole 121 is provided in the first protrusion 123. The first protrusion 123 may create a gap between the booster pump 130 and the bottom of the mount slot 122. The booster pump 130 cannot directly contact the entire bottom of the mount slot 122, to provide a certain vibration isolation effect. In this way, the vibration generated by the booster pump 130 is first transmitted to the first protrusion 123, and is attenuated when transmitting the vibration to the first protrusion 123, which reduces the impact of the vibration at the entire water purifier 100.

In addition, in other embodiments, shock-absorbing materials such as rubber pads or other flexible materials may be added between the first protrusion 123 and the booster pump 130. This structure and design may more effectively utilize the shock-absorbing performance of these materials, which further reduces the noise generated by the booster pump 130.

As shown in FIG. 24 and FIG. 25, in some embodiments of the present application, a bottom wall of the mount slot 122 is provided with a second protrusion 124, and the first protrusion 123 is provided at the second protrusion 124. The providing of the second protrusion 124 increases the space between the bottom wall and the booster pump 130, and the superposition of the first protrusion 123 and the second protrusion 124 forms a multi-layer shock-absorbing structure, which helps to further disperse and attenuate the vibration energy generated by the operation of the booster pump 130, and improve the shock-absorbing performance of the entire device. In addition, the second protrusion 124 provides an additional base for the first protrusion 123, which enhances the strength and stability of the entire support structure.

As shown in FIG. 24, in some embodiments of the present application, a height h1 of the first protrusion 123 may be 8 mm-15 mm, for example, the height h1 of the first protrusion 123 may be 9 mm.

As shown in FIG. 25, in some embodiments of the present application, a height h2 of the second protrusion 124 may be 6 mm-12 mm, for example, the height h2 of the second protrusion 124 may be 9 mm.

In some embodiments of the present application, the pump body mount base 120 is provided with a mount slot 122, and the booster pump 130 is provided inside the mount slot 122. The bottom wall of the mount slot 122 is provided with a recessed part (not shown in the figures), and the mount hole 121 is provided at the recessed part. The recessed part may serve as a reference for aligning and positioning the booster pump 130, which facilitates the correct placement and fixation of the booster pump 130 during mounting, and ensures that the booster pump 130 is provided in the accurate position.

In some embodiments of the present application, the water purifier 100 further includes a pump body mount plate (not shown in the figures), which is provided at a side of the pump body mount base 120. The pump body mount plate is detachably connected to the pump body mount base 120 through a bolt 150, and the booster pump 130 is provided at the pump body mount plate, which may simplify the mounting of the booster pump 130. As the pump body mount plate is detachably connected to the pump body mount base 120 through the bolt 150, it may facilitate the maintenance and replacement of the booster pump 130. The booster pump 130 along with the mount plate may be removed as long as the bolt 150 is disassembled.

In other embodiments, the pump body mount plate may be made of materials with certain elasticity, such as adding shock-absorbing gaskets between the pump body mount plate and the pump body mount base 120. In this way, the pump body mount plate may serve as an additional buffer layer between the booster pump 130 and the pump body mount base 120, which absorbs vibration and reduces noise.

As shown in FIG. 21 and FIG. 23, in some embodiments of the present application, a plurality of fix bases 140 are provided in array at the surface of the pump body mount base 120. The plurality of fix bases 140 may evenly distribute the vibration and load generated by the booster pump 130, reduce the pressure at a single fixed point, and improve the stability and durability of the entire mount system. In addition, the plurality of fixed points may help maintain the precise position of the booster pump 130 relative to the pump body mount base 120, which improves assembly precision and stability during operation. Multi-point support may make the force at the bottom wall of the pump body mount base 120 more uniform, which avoids wear or damage to the bottom wall of the pump body mount base 120 caused by local overload at a certain point.

As shown in FIG. 20 and FIG. 21, in some embodiments of the present application, the pump body mount base 120 and the base body 110 are integrally formed. Integrated parts are generally more robust and stable in structure than composite parts, without connection points or seams, which may reduce potential weaknesses and failure rates. Integrated parts reduce assembly workload, which saves assembly time and corresponding costs. The integrated design may make the overall structure more compact and provide more continuous vibration absorption characteristics, which helps reduce noise and vibration during device operation. In addition, integrated parts typically have a smoother surface, a more aesthetically pleasing appearance, and may ensure consistency between different production batches of the product. The integrated structure has no gaps or seams, which makes it easy to clean and maintain, and reduces the accumulation of dust and dirt inside the water purifier 100.

As shown in FIG. 26, in some embodiments of the present application, the base body 110 is further provided with a control panel mount base (not shown in the figures), a filter cartridge support base 190, and a water path plate mount base (not shown in the figures), where a water path plate mount space (not shown in the figures) is provided inside the water path plate mount base. The base body 110, the control panel mount base, the pump body mount base 120, the filter cartridge support base 190, and the water path plate mount base are all integrally formed, and the control panel mount base, the pump body mount base 120, and the water path plate mount base are all located at the same side of the base body 110. The peripheral wall of the base body 110 is provided with a mount port 111, and when mounting various assemblies of the base body 110, the filter cartridge (not shown in the figures) may be mounted into the filter cartridge support base 190 from the mount port 111, and then the booster pump 130, the water path plate 160, and the control panel assembly 170 may be mounted at the same side of the base body 110. In this way, when assembling the water purifier 100, there is no need to flip the base body 110, which makes the mounting faster and easier.

Finally, it should be noted that the above embodiments are only used to illustrate the present application and not to limit it. Although the present application has been described in detail with reference to the embodiments, those skilled in the art should understand that various combinations, modifications, or equivalent substitutions of the solution of the present application do not depart from the scope of the solution of the present application, and should be covered within the scope of protection of the present application.

1.-46. (canceled)

47. A water purifier comprising:
a base body; and
a filter cartridge support base integrally formed with the base body, a semi-open accommodation space being provided inside the filter cartridge support base and being configured to accommodate a filter cartridge.

48. The water purifier of claim 47, wherein:
the filter cartridge support base is provided with a hollow part communicating with the accommodation space; or
the filter cartridge support base is provided with a plurality of hollow parts communicating with the accommodation space, at least one of the hollow parts being located at an end portion of the filter cartridge support base facing a water path plate.

49. The water purifier of claim 47, wherein a cross-section of the filter cartridge support base is an arc, a diameter of the arc being greater than a diameter of the filter cartridge.

50. The water purifier of claim 49, wherein:
a difference between the diameter of the arc and the diameter of the filter cartridge is 1 mm-3 mm; and/or
a center angle corresponding to the arc is 180°-270°.

51. The water purifier of claim 47, wherein a thickness of the filter cartridge support base is 1.5 mm-3.5 mm.

52. The water purifier of claim 47, wherein:
the filter cartridge support base is one of a plurality of filter cartridge support bases arranged side by side;
a water path plate mount space is provided inside the base body, an opening of the water path plate mount space facing a side of the base body, and an opening of the accommodation space facing another side of the base body; and/or
a peripheral wall of the base body is provided with a mount port communicating with the accommodation space and configured to allow the filter cartridge be mounted into the accommodation space through the mount port.

53. A housing assembly comprising:
an enclose plate, a mount space being formed through the enclose plate, and a side of the mount space being open;
a filter cartridge mount base configured to accommodate a filter cartridge;
a first mount base accommodating a water path plate and connected to the filter cartridge mount base;
a second mount base accommodating a booster pump and connected to the first mount base; and
a third mount base accommodating a control panel and connected to the second mount base;
wherein the filter cartridge mount base, the first mount base, the second mount base, and the third mount base are all provided inside the mount space, and an opening of an accommodation space formed by the first mount base, an opening of an accommodation space formed by the second mount base, and an opening of an accommodation space formed by the third mount base all face a side of the mount space.

54. The housing assembly of claim 53, wherein:
a bottom wall of the first mount base is provided with a limit hole limiting the water path plate; and/or
a plurality of fix blocks are provided inside the first mount base at intervals, the fix blocks protruding from the bottom wall of the first mount base, and the fix blocks abutting against the water path plate and being connected to the water path plate.

55. The housing assembly of claim 53, wherein a bottom wall of the second mount base is provided with a plurality of plug holes connected to the booster pump.

56. The housing assembly of claim 55, wherein:
the plug holes are threaded blind holes; and/or
the plurality of plug holes are provided in array.

57. The housing assembly of claim 53, wherein:
a bottom wall of the third mount base is provided with a buckle, the buckle being a through hole connected to the control panel; and/or
the third mount base includes adjacent first side wall and second side wall, one of the first side wall and the second side wall being provided with a limit plate, the limit plate and another of the first side wall and the second side wall forming a position slot, and the control panel being embedded inside the position slot.

58. The housing assembly of claim 53, wherein the enclose plate includes a plurality of sub-plates connected in sequence to form the mount space.

59. The housing assembly of claim 58, wherein:
the plurality of sub-plates include a plate body, the filter cartridge mount base including a first end and a second end, the first end being connected to the plate body, and the plate body being provided with a mount port communicating with the filter cartridge mount base; and/or
the second end is provided with a communication port communicating with the first mount base.

60. The housing assembly of claim 59, further comprising:
a side plate connected to the enclose plate and covered at the mount space.

61. A water purifier comprising:
the housing assembly of claim 53;
a filter cartridge provided inside the filter cartridge mount base of the housing assembly;
a water path plate provided inside the first mount base of the housing assembly and connected to and communicating with the filter cartridge;
a booster pump provided inside the second mount base of the housing assembly and connected to and communicating with the water path plate; and
a control panel provided inside the third mount base of the housing assembly and connected to the booster pump.

62. A water purifier comprising:
a base body provided with a plug slot;
a filter cartridge support base provided at a side of the plug slot; and
a water path plate plugged into the plug slot and fixedly connected to the filter cartridge support base.

63. The water purifier of claim 62, wherein:
the water path plate is provided with a first plug member, the base body is provided with a second plug member, the first plug member and the second plug member being detachably plugged and matched, one of the first plug member and the second plug member being a limit rib and another of the first plug member and the second plug member being a limit hole; and/or
a plurality of the first plug members are provided at intervals at the water path plate.

64. The water purifier of claim 63, wherein the limit rib includes:
a strip section protruding from a surface of the water path plate, a length of the strip section being greater than a diameter of the limit hole; and
a plug section integrally formed with the strip section, the plug section being located inside the limit hole.

65. The water purifier of claim 64, wherein a cross-section of the plug section is of a “+” shape; and/or
an end face of a free end of the plug section is provided with a cut slope.

66. The water purifier of claim 62, wherein:
an opening of the plug slot faces a side of the base body, a peripheral wall of the base body being provided with a mount port;
an end portion of the filter cartridge support base facing the water path plate is provided with a hollow part, the filter cartridge being connected to the water path plate at the hollow part;
the base body is provided with at least one reserve port for accessing a reserve water path;
the filter cartridge support base and the base body are integrally formed; and/or
the base body is provided with a pump body mount slot, an opening direction of the pump body mount slot being same as an opening direction of the plug slot.
